(19) United States
(12) Patent Application Publication
(10) Pub. No.: US 2015/0355436 A1
(43) Pub. Date: Dec. 10, 2015

(54) ZOOM LENS AND IMAGING APPARATUS

(71) Applicant: FUJIFILM Corporation, Tokyo (JP)

(72) Inventors: Yasutaka SHIMADA, Saitama-ken (JP); Shinkichi IKEDA, Saitama-ken (JP)

(21) Appl. No.: 14/726,763

(22) Filed: Jun. 1, 2015

(30) Foreign Application Priority Data
Jun. 6, 2014 (JP) 117373/2014
Mar. 6, 2015 (JP) 045035/2015

(51) Int. Cl. G02B 13/00; H04N 5/225; H04N 5/232; G02B 15/14

(52) U.S. Cl. CPC G02B 13/0015; G02B 15/14; H04N 5/2254; H04N 5/23296

(57) ABSTRACT

A five-group zoom lens includes, in order from the object side, positive, negative, positive, positive, and positive groups. During magnification change, the first and fifth groups are fixed relative to the image plane, and the second, third, and fourth groups are moved to change distances therebetween. During magnification change from the wide-angle end to the telephoto end, the second group is moved from the object side toward the image plane side, the fourth group is moved from the image plane side toward the object side, and a third-fourth combined lens group, which is the combination of the third group combined and the fourth group, and the second group simultaneously pass through their respective points at which the imaging magnification is −1×. The third-fourth combined lens group includes at least one negative lens, and satisfies the condition expression (1) below:

29<νdG34n<37 (1).

### CROSS-REFERENCE TO RELATED APPLICATIONS

The present application claims priority under 35 U.S.C. §119 to Japanese Patent Application No. 2014-117373, filed on Jun. 6, 2014, and Japanese Patent Application No. 2015-045035, filed on Mar. 6, 2015. Each of the above applications is hereby expressly incorporated by reference, in its entirety, into the present application.

### BACKGROUND OF THE INVENTION

1. Field of the Invention

The present invention relates to a zoom lens for use with electronic cameras, such as digital cameras, video cameras, broadcasting cameras, monitoring cameras, etc., and an imaging apparatus provided with the zoom lens.

2. Description of the Related Art

As a zoom lens for television cameras, those having a five-group configuration as a whole for achieving high performance, where three lens groups are moved during magnification change, are proposed in Japanese Unexamined Patent Publication Nos. 7(1995)-248449 and 2009-128491 (hereinafter, Patent Documents 1 and 2, respectively).

Further, as a zoom lens having relatively high zoom magnification, those having a four-group configuration as a whole, where two lens groups are moved during magnification change, are proposed in Japanese Unexamined Patent Publication Nos. 2010-091788 and 2011-039399 (hereinafter, Patent Documents 3 and 4, respectively).

### SUMMARY OF THE INVENTION

With high-magnification zoom lenses, in general, increase of amounts of movement of the lens elements for magnification change results in increased distance from the stop to the front lens element, and it is difficult to achieve wide angle of view without increasing the lens diameter and the weight of the lens.

Patent Documents 1 and 2 do not achieve sufficiently high zoom magnification. Patent Documents 3 and 4 do achieve high zoom magnification; however, they do not achieve sufficiently wide angle of view.

In view of the above-described circumstances, the present invention is directed to providing a zoom lens that is compact and has high optical performance, and achieves both high magnification and wide angle of view, as well as an imaging apparatus provided with the zoom lens.

An aspect of the zoom lens of the invention is a zoom lens consisting of, in order from the object side, a first lens group having a positive refractive power, a second lens group having a negative refractive power, a third lens group having a positive refractive power, a fourth lens group having a positive refractive power, and a fifth lens group having a positive refractive power,

wherein, during magnification change, the first lens group and the fifth lens group are fixed relative to an image plane, and the second lens group, the third lens group, and the fourth lens group are moved to change distances therebetween,

during magnification change from the wide-angle end to the telephoto end, the second lens group is moved from the object side toward the image plane side, and the fourth lens group is moved from the image plane side toward the object side,

during magnification change from the wide-angle end to the telephoto end, a third-fourth combined lens group, which is the combination of the third lens group and the fourth lens group, and the second lens group simultaneously pass through their respective points at which the imaging magnification is −1×,

the third-fourth combined lens group comprises at least one negative lens, and

the condition expression (1) below is satisfied:

29<νdG34n<37 (1),

where νdG34n is an average value of Abbe numbers with respect to the d-line of all negative lenses of the third-fourth combined lens group.

It is more preferred that the condition expression (1-1) below be satisfied:

29.5<νdG34n<36 (1-1).

It is preferred that, in the zoom lens of the invention, the first lens group consist of, in order from the object side, a first-group first lens having a negative refractive power, a first-group second lens having a positive refractive power, a first-group third lens having a positive refractive power, a first-group fourth lens having a positive refractive power, and a first-group fifth lens which is a positive meniscus lens with the convex surface toward the object side, and

the condition expressions (2) and (3) below be satisfied:

1.75<ndL11 (2), and

νdL11<45 (3),

where ndL11 is a refractive index with respect to the d-line of the first-group first lens, and νdL11 is an Abbe number with respect to the d-line of the first-group first lens. It is more preferred that the condition expression (2-1) and/or (3-1) below be satisfied:

1.80<ndL11 (2-1),

νdL11<40 (3-1).

It is preferred that the distance between the third lens group and the fourth lens group be maximized when they are on the wide angle side of their points at which the imaging magnification of the third-fourth combined lens group is −1×.

It is preferred that the distance between the third lens group and the fourth lens group be minimized at the telephoto end.

It is preferred that the distance between the second lens group and the third lens group at the telephoto end be smaller than that at the wide-angle end.

It is preferred that the third lens group comprise at least one aspheric surface.

It is preferred that the fourth lens group comprise at least one aspheric surface.

It is preferred that a second-group first lens, which is the most object-side negative lens of the second lens group, satisfy the condition expression (4) below:

25<νd21<45 (4),

where νd21 is an Abbe number with respect to the d-line of the second-group first lens. It is more preferred that the condition expression (4-1) below be satisfied:

28<νd21<40 (4-1).

The imaging apparatus of the invention comprises the above-described zoom lens of the invention.

It should be noted that the expression “consisting/consist of” as used herein means that the zoom lens may include, besides the elements recited above: lenses substantially without any power; optical elements other than lenses, such as a stop, a mask, a cover glass, and filters; and mechanical components, such as a lens flange, a lens barrel, an image sensor, a camera shake correction mechanism, etc.

The sign (positive or negative) with respect to the surface shape and the refractive power of any lens including an aspheric surface among the lenses described above is about the paraxial region.

The zoom lens of the invention consists of, in order from the object side, the first lens group having a positive refractive power, the second lens group having a negative refractive power, the third lens group having a positive refractive power, the fourth lens group having a positive refractive power, and the fifth lens group having a positive refractive power, wherein, during magnification change, the first lens group and the fifth lens group are fixed relative to the image plane, and the second lens group, the third lens group, and the fourth lens group are moved to change distances therebetween, during magnification change from the wide-angle end to the telephoto end, the second lens group is moved from the object side toward the image plane side, and the fourth lens group is moved from the image plane side toward the object side, during magnification change from the wide-angle end to the telephoto end, the third-fourth combined lens group, which is the combination of the third lens group and the fourth lens group, and the second lens group simultaneously pass through their respective points at which the imaging magnification is −1×, the third-fourth combined lens group comprises at least one negative lens, and the condition expression (1) below is satisfied:

29<νdG34n<37 (1).

This configuration allows providing a compact zoom lens which has high optical performance and achieves both high magnification and wide angle.

The imaging apparatus of the invention, which is provided with the zoom lens of the invention, can be made compact, and allows obtaining high image-quality, high magnification and wide-angle images.

### BRIEF DESCRIPTION OF THE DRAWINGS

FIG. 1 is a sectional view illustrating the lens configuration of a zoom lens according to one embodiment of the invention (a zoom lens of Example 1),

FIG. 2 is a diagram showing optical paths through the zoom lens according to one embodiment of the invention (the zoom lens of Example 1),

FIG. 3 is a sectional view illustrating the lens configuration of a zoom lens of Example 2 of the invention,

FIG. 4 is a diagram showing optical paths through the zoom lens of Example 2 of the invention,

FIG. 5 is a sectional view illustrating the lens configuration of a zoom lens of Example 3 of the invention,

FIG. 6 is a diagram showing optical paths through the zoom lens of Example 3 of the invention,

FIG. 7 is a sectional view illustrating the lens configuration of a zoom lens of Example 4 of the invention,

FIG. 8 is a diagram showing optical paths through the zoom lens of Example 4 of the invention,

FIG. 9 is a sectional view illustrating the lens configuration of a zoom lens of Example 5 of the invention,

FIG. 10 is a diagram showing optical paths through the zoom lens of Example 5 of the invention,

FIG. 11 is a sectional view illustrating the lens configuration of a zoom lens of Example 6 of the invention,

FIG. 12 is a diagram showing optical paths through the zoom lens of Example 6 of the invention,

FIG. 13 is a sectional view illustrating the lens configuration of a zoom lens of Example 7 of the invention,

FIG. 14 is a diagram showing optical paths through the zoom lens of Example 7 of the invention,

FIG. 15 is a sectional view illustrating the lens configuration of a zoom lens of Example 8 of the invention,

FIG. 16 is a diagram showing optical paths through the zoom lens of Example 8 of the invention,

FIG. 17 is a sectional view illustrating the lens configuration of a zoom lens of Example 9 of the invention,

FIG. 18 is a diagram showing optical paths through the zoom lens of Example 9 of the invention,

FIG. 19 shows aberration diagrams of the zoom lens of Example 1 of the invention,

FIG. 20 shows aberration diagrams of the zoom lens of Example 2 of the invention,

FIG. 21 shows aberration diagrams of the zoom lens of Example 3 of the invention,

FIG. 22 shows aberration diagrams of the zoom lens of Example 4 of the invention,

FIG. 23 shows aberration diagrams of the zoom lens of Example 5 of the invention,

FIG. 24 shows aberration diagrams of the zoom lens of Example 6 of the invention,

FIG. 25 shows aberration diagrams of the zoom lens of Example 7 of the invention,

FIG. 26 shows aberration diagrams of the zoom lens of Example 8 of the invention,

FIG. 27 shows aberration diagrams of the zoom lens of Example 9 of the invention, and

FIG. 28 is a diagram illustrating the schematic configuration of an imaging apparatus according to an embodiment of the invention.

### DESCRIPTION OF THE PREFERRED EMBODIMENTS

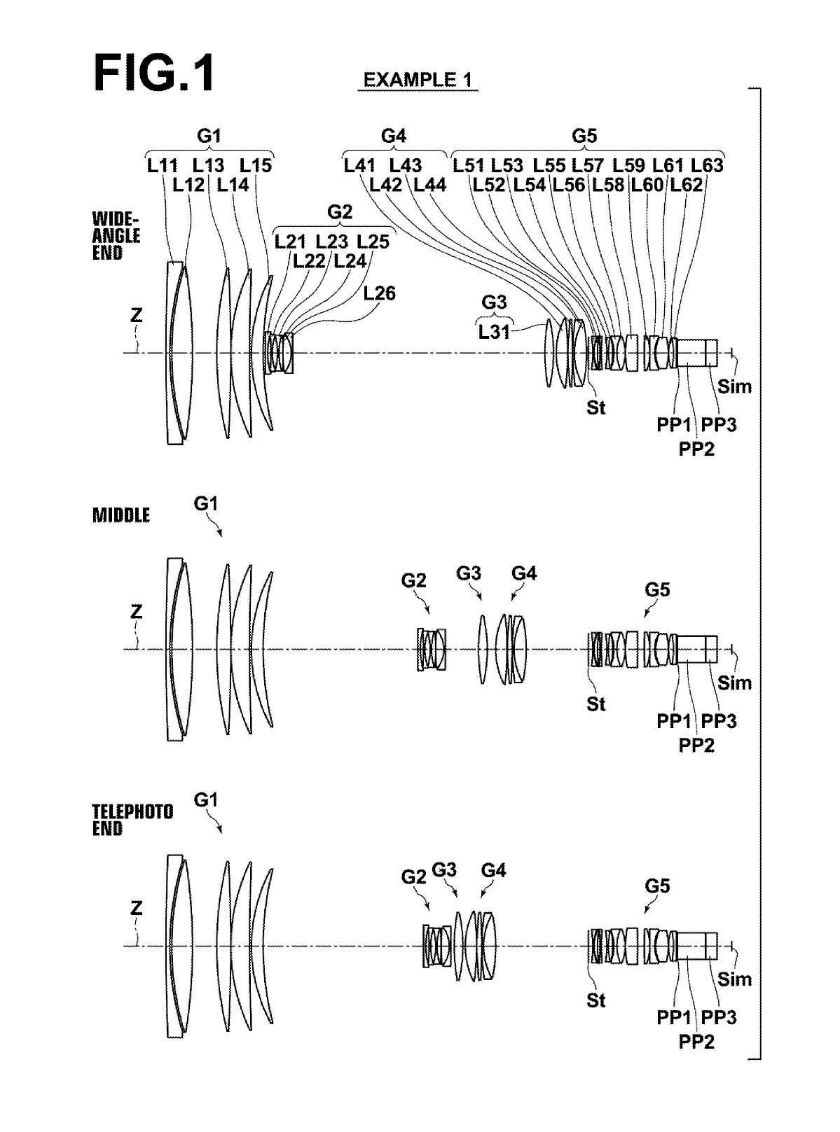

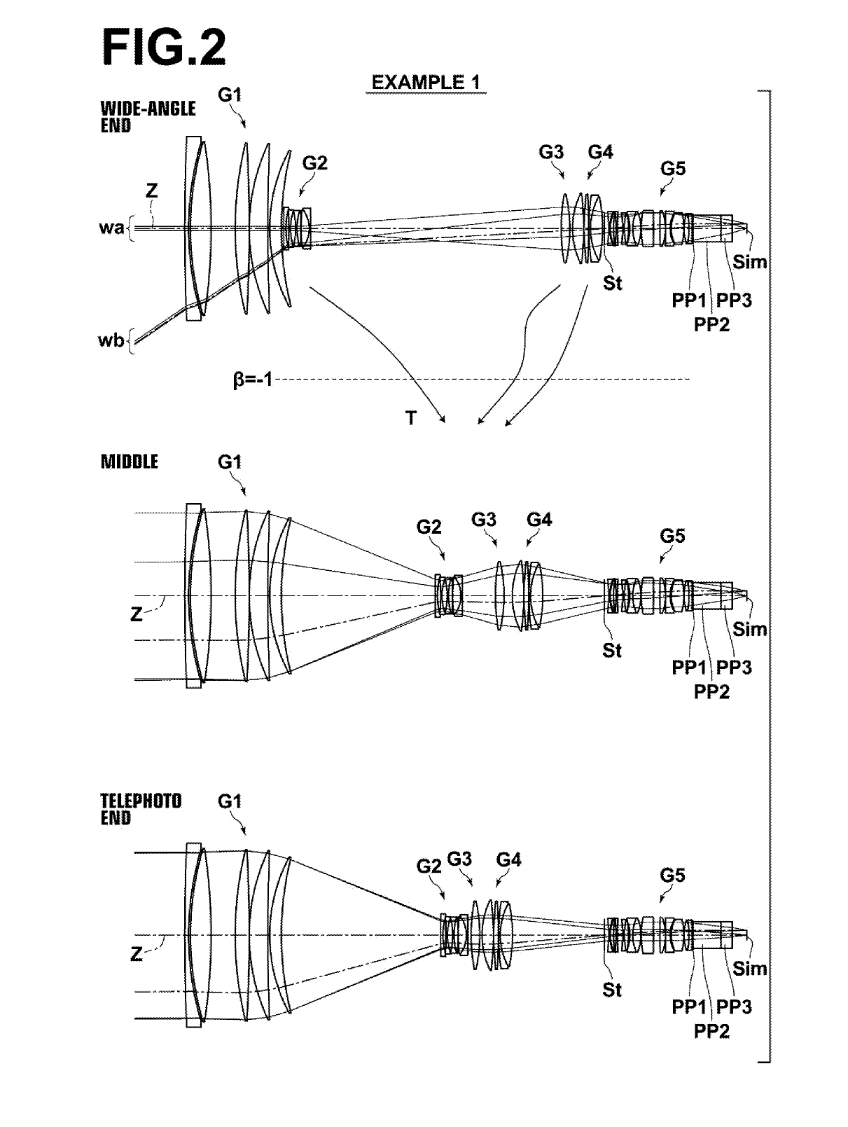

Hereinafter, embodiments of the present invention will be described in detail with reference to the drawings. FIG. 1 is a sectional view illustrating the lens configuration of a zoom lens according to one embodiment of the invention, and FIG. 2 is a diagram showing optical paths through the zoom lens. The configuration example shown in FIGS. 1 and 2 is the same as the configuration of a zoom lens of Example 1, which will be described later. In FIGS. 1 and 2, the left side is the object side and the right side is the image plane side. An aperture stop St shown in each drawing does not necessarily represent the size and the shape thereof, but represents the position thereof along the optical axis Z. In the diagram showing optical paths of FIG. 2, an on-axis bundle of rays wa, a bundle of rays wb at the maximum angle of view, loci of movement (the arrows shown in the drawing) of lens groups during magnification change, and points at which the imaging magnification is −1× (the horizontal dashed line in the drawing) are shown.

As shown in FIG. 1, this zoom lens includes, in order from the object side, a first lens group G1 having a positive refractive power, a second lens group G2 having a negative refractive power, a third lens group G3 having a positive refractive power, a fourth lens group G4 having a positive refractive power, an aperture stop St, and a fifth lens group G5 having a positive refractive power.

When this zoom lens is used with an imaging apparatus, it is preferred to provide a cover glass, a prism, and various filters, such as an infrared cutoff filter and a low-pass filter, etc., between the optical system and an image plane Sim depending on the configuration of the camera on which the lens is mounted. In the example shown in FIGS. 1 and 2, optical members PP1 to PP3 in the form of plane-parallel plates, which are assumed to represent such elements, are disposed between the lens system and the image plane Sim.

During magnification change, the first lens group G1 and the fifth lens group G5 are fixed relative to the image plane Sim, and the second lens group G2, the third lens group G3, and the fourth lens group G4 are moved to change distances therebetween. During magnification change from the wide-angle end to the telephoto end, the second lens group G2 is moved from the object side toward the image plane side, and the fourth lens group G4 is moved from the image plane side toward the object side. Also, during magnification change from the wide-angle end to the telephoto end, a third-fourth combined lens group, which is the combination of the third lens group G3 and the fourth lens group G4, and the second lens group G2 simultaneously pass through their respective points at which the imaging magnification is −1×.

In this zoom lens, the second lens group G2 works to effect magnification change, and the third lens group G3 and the fourth lens group G4 work to correct for changes of the image plane along with magnification change. Further, the third lens group G3 and the fourth lens group G4 are moved relative to each other, and this allows successfully correcting for changes of spherical aberration and coma aberration during magnification change, as well as correcting for changes of the image plane during magnification change.

Further, configuring the third-fourth combined lens group, which is the combination of the third lens group G3 and the fourth lens group G4, and the second lens group G2 to simultaneously pass through their respective points at which the imaging magnification is −1× during magnification change from the wide-angle end to the telephoto end allows achieving a compact high-magnification zoom lens with successfully suppressed changes of aberrations.

The third-fourth combined lens group is configured to include at least one negative lens and satisfy the condition expression (1) below. Satisfying the lower limit of the condition expression (1) allows successfully correcting chromatic aberration at the fourth lens group G4. Satisfying the upper limit of condition expression (1) allows successfully correcting spherical aberration and coma aberration. That is, satisfying the condition expression (1) allows successfully correcting spherical aberration and coma aberration during magnification change while successfully correcting longitudinal chromatic aberration that occurs at the telephoto side during magnification change, and this allows achieving a high-magnification zoom lens with successfully suppressed changes of aberrations across the entire zoom range. It should be noted that higher performance can be obtained when the condition expression (1-1) below is satisfied.

29<νdG34n<37 (1),

29.5<νdG34n<36 (1-1),

where νdG34n is an average value of Abbe numbers with respect to the d-line of all negative lenses of the third-fourth combined lens group.

It is preferred that, in the zoom lens of this embodiment, the first lens group G1 include, in order from the object side, a first-group first lens L11 having a negative refractive power, a first-group second lens L12 having a positive refractive power, a first-group third lens L13 having a positive refractive power, a first-group fourth lens L14 having a positive refractive power, and a first-group fifth lens L15 which is a positive meniscus lens with the convex surface toward the object side, and the first lens group G1 satisfy the condition expressions (2) and (3) below. The above-described configuration of the first lens group G1 allows suppressing increase of the weight. Satisfying the condition expressions (2) and (3) allows successfully correcting spherical aberration and coma aberration while suppressing chromatic aberration across the entire zoom range. It should be noted that higher performance can be obtained when the condition expression (2-1) and/or (3-1) below is satisfied.

1.75<ndL11 (2),

1.80<ndL11 (2-1),

νdL11<45 (3),

νdL11<40 (3-1),

where ndL11 is a refractive index with respect to the d-line of the first-group first lens, and νdL11 is an Abbe number with respect to the d-line of the first-group first lens.

It is preferred that the distance between the third lens group G3 and the fourth lens group G4 be maximized when they are on the wide angle side of their points at which the imaging magnification of the third-fourth combined lens group is −1×. On the wide angle side of their points at which the imaging magnification of the third-fourth combined lens group is −1×, the ray height at the first-group first lens L11, which is at the most object-side position, is high, and the configuration where the distance between the third lens group G3 and the fourth lens group G4 is maximized when they are on the wide angle side of their points at which the imaging magnification of the third-fourth combined lens group is −1× is advantageous for achieving wide angle of view.

It is preferred that the distance between the third lens group G3 and the fourth lens group G4 be minimized at the telephoto end. Since the second lens group G2, the third lens group G3 and the fourth lens group G4 are brought close to each other at the telephoto end, the configuration where the distance between the third lens group G3 and the fourth lens group G4 is minimized at the telephoto end is advantageous for achieving high magnification.

It is preferred that the distance between the second lens group G2 and the third lens group G3 at the telephoto end be smaller than that at the wide-angle end. This configuration is advantageous for achieving high magnification.

It is preferred that the third lens group G3 include at least one aspheric surface. Providing the third lens group G3 with at least one aspheric surface allows more effective correction of spherical aberration and coma aberration. Also, this configuration enhances the advantageous effect provided by changing the distance between the third lens group G3 and the fourth lens group G4 during magnification change.

It is preferred that the fourth lens group G4 include at least one aspheric surface. Providing the fourth lens group G4, which is at the most image plane-side position among the lens groups which are moved during magnification change, with at least one aspheric surface allows successfully correcting spherical aberration across the entire zoom range.

It is preferred that a second-group first lens, which is the most object-side negative lens of the second lens group G2, satisfy the condition expression (4) below. Satisfying the lower limit of the condition expression (4) allows suppressing changes of primary lateral chromatic aberration and primary longitudinal chromatic aberration during magnification change. Satisfying the upper limit of condition expression (4) allows correcting secondary lateral chromatic aberration at the wide-angle end which occurs at the first lens group G1 when secondary longitudinal chromatic aberration at the telephoto end is corrected, thereby allowing well balanced correction of the secondary longitudinal chromatic aberration at the telephoto end, the lateral chromatic aberration at the telephoto end, and the secondary lateral chromatic aberration at the wide-angle end. It should be noted that higher performance can be obtained when the condition expression (4-1) below is satisfied.

25<νd21<45 (4),

28<νd21<40 (4-1),

where νd21 is an Abbe number with respect to the d-line of the second-group first lens.

In the example shown in FIGS. 1 and 2, the optical members PP1 to PP3 are disposed between the lens system and the image plane Sim. However, in place of disposing the various filters, such as a low-pass filter and a filter that cuts off a specific wavelength range, between the lens system and the image plane Sim, the various filters may be disposed between the lenses, or coatings having the same functions as the various filters may be applied to the lens surfaces of some of the lenses.

Next, numerical examples of the zoom lens of the invention are described.

First, a zoom lens of Example 1 is described. FIG. 1 is a sectional view illustrating the lens configuration of the zoom lens of Example 1. FIG. 2 is a diagram showing optical paths through the zoom lens of Example 1. It should be noted that, in FIGS. 1 and 2, and FIGS. 3 to 18 corresponding to Examples 2 to 9, which will be described later, the left side is the object side and the right side is the image plane side. The aperture stop St shown in the drawings does not necessarily represent the size and the shape thereof, but represents the position thereof along the optical axis Z. The diagram showing optical paths shows an on-axis bundle of rays wa, a bundle of rays wb at the maximum angle of view, loci of movement (the arrows shown in the drawing) of the lens groups during magnification change, and points at which the imaging magnification is −1× (the horizontal dashed line in the drawing).

In the zoom lens of Example 1, the first lens group G1 is formed by five lenses, i.e., lenses L11 to L15, the second lens group G2 is formed by six lenses, i.e., lenses L21 to L26, the third lens group G3 is formed by one lens L31, the fourth lens group G4 is formed by four lenses, i.e., lenses L41 to L44, and the fifth lens group G5 is formed by thirteen lenses, i.e., lenses L51 to L63.

Table 1 shows basic lens data of the zoom lens of Example 1, Table 2 shows data about specifications of the zoom lens, Table 3 shows data about surface distances to be changed of the zoom lens, and Table 4 shows data about aspheric coefficients of the zoom lens. In the following description, meanings of symbols used in the tables are explained with respect to Example 1 as an example. The same explanations basically apply to those with respect to Examples 2 to 9.

In the lens data shown in Table 1, each value in the column of “Surface No.” represents each surface number, where the object-side surface of the most object-side element is the 1st surface and the number is sequentially increased toward the image plane side, each value in the column of “Radius of Curvature” represents the radius of curvature of each surface, and each value in the column of “Surface Distance” represents the distance along the optical axis Z between each surface and the next surface. Each value in the column of “nd” represents the refractive index with respect to the d-line (the wavelength of 587.6 nm) of each optical element, each value in the column of “νd” represents the Abbe number with respect to the d-line (the wavelength of 587.6 nm) of each optical element, and each value in the column of “θg,F” represents the partial dispersion ratio of each optical element.

It should be noted that the partial dispersion ratio θg,F is expressed by the formula below:

θg,F=(Ng−NF)/(NF−NC),

where Ng is a refractive index with respect to the g-line, NF is a refractive index with respect to F-line, and NC is a refractive index with respect to the C-line.

The sign with respect to the radius of curvature is provided such that a positive radius of curvature indicates a surface shape that is convex toward the object side, and a negative radius of curvature indicates a surface shape that is convex toward the image plane side. The basic lens data also includes data of the aperture stop St and the optical members PP1 to PP3, and the surface number and the text “(stop)” are shown at the position in the column of the surface number corresponding to the aperture stop St. In the lens data shown in Table 1, the value of each surface distance that is changed during magnification change is represented by the symbol “DD[surface number]”. The numerical value corresponding to each DD[surface number] is shown in Table 3.

The data about specifications shown in Table 2 show values of zoom magnification, focal length f′, back focus Bf′, f-number FNo., and total angle of view 2ω.

With respect to the basic lens data, the data about specifications, and the data about surface distances to be changed, the unit of angle is degrees, and the unit of length is millimeters; however, any other suitable units may be used since optical systems are usable when they are proportionally enlarged or reduced.

In the lens data shown in Table 1, the symbol “*” is added to the surface number of each aspheric surface, and a numerical value of the paraxial radius of curvature is shown as the radius of curvature of each aspheric surface. In the data about aspheric coefficients shown in Table 4, the surface number of each aspheric surface and aspheric coefficients about each aspheric surface are shown. The aspheric coefficients are values of the coefficients KA and Am (where m=3, . . . , 20) in the formula of aspheric surface shown below:

Zd=C·h²/{1+(1−KA·C²·h²)^{1/2}}+ΣAm·h^{m},

where Zd is a depth of the aspheric surface (a length of a perpendicular line from a point with a height h on the aspheric surface to a plane tangent to the apex of the aspheric surface and perpendicular to the optical axis), h is the height (a distance from the optical axis), C is a reciprocal of the paraxial radius of curvature, and KA and Am are aspheric coefficients (where m=3, . . . , 20).

TABLE 1
Example 1 - Lens Data

| Surface | Radius of | Surface | | | |
|---|---|---|---|---|---|
| No. | Curvature | Distance | nd | νd | θg, F |
| 1 | 2758.4371 | 4.4000 | 1.83400 | 37.16 | 0.57759 |
| 2 | 347.8180 | 2.2600 | | | |
| 3 | 353.7539 | 24.3000 | 1.43387 | 95.20 | 0.53733 |
| 4 | −666.4931 | 28.4000 | | | |
| 5 | 418.1856 | 16.3800 | 1.43387 | 95.20 | 0.53733 |
| 6 | −1937.2403 | 0.1100 | | | |
| 7 | 230.5824 | 22.0200 | 1.43387 | 95.20 | 0.53733 |
| 8 | 2488.7921 | 2.1100 | | | |
| 9 | 193.0855 | 13.7800 | 1.43875 | 94.93 | 0.53433 |
| 10 | 375.2290 | DD[10] | | | |
| *11 | ∞ | 2.8000 | 1.90366 | 31.32 | 0.59481 |
| 12 | 87.7087 | 3.6231 | | | |
| 13 | −276.3450 | 1.7000 | 2.00100 | 29.13 | 0.59952 |
| 14 | 61.6678 | 6.0762 | | | |
| 15 | −81.4336 | 1.7200 | 1.90043 | 37.37 | 0.57720 |
| 16 | 71.5780 | 4.6500 | 1.80809 | 22.76 | 0.63073 |
| 17 | −491.0384 | 0.1200 | | | |
| 18 | 197.1668 | 9.6900 | 1.80809 | 22.76 | 0.63073 |
| 19 | −36.8210 | 1.7000 | 1.81600 | 46.62 | 0.55682 |
| 20 | −1318.6602 | DD[20] | | | |
| 21 | 228.3648 | 10.2000 | 1.49700 | 81.54 | 0.53748 |
| *22 | −164.6345 | DD[22] | | | |
| 23 | 92.3550 | 13.4300 | 1.43700 | 95.10 | 0.53364 |
| 24 | −316.4534 | 0.2500 | | | |
| *25 | 227.5428 | 5.7000 | 1.43700 | 95.10 | 0.53364 |
| 26 | −613.2058 | 0.1200 | | | |
| 27 | 264.9897 | 2.0200 | 1.80000 | 29.84 | 0.60178 |
| 28 | 78.0000 | 14.2700 | 1.43700 | 95.10 | 0.53364 |
| 29 | −182.7058 | DD[29] | | | |
| 30 (stop) | ∞ | 5.2100 | | | |
| 31 | −143.8399 | 1.5000 | 1.77250 | 49.60 | 0.55212 |
| 32 | 62.1750 | 0.1200 | | | |
| 33 | 45.5708 | 3.9900 | 1.80518 | 25.46 | 0.61572 |
| 34 | 122.8996 | 3.0300 | | | |
| 35 | −124.1653 | 1.5000 | 1.48749 | 70.23 | 0.53007 |
| 36 | 301.7353 | 6.3100 | | | |
| 37 | −119.7638 | 1.8000 | 1.80400 | 46.58 | 0.55730 |
| 38 | 79.0480 | 4.8500 | 1.80518 | 25.43 | 0.61027 |
| 39 | −105.3465 | 1.6800 | | | |
| 40 | −50.3148 | 3.5000 | 1.88300 | 40.76 | 0.56679 |
| 41 | 49.1400 | 9.7900 | 1.54072 | 47.23 | 0.56511 |
| 42 | −49.1400 | 0.1200 | | | |
| 43 | 103.1349 | 14.2700 | 1.83481 | 42.73 | 0.56486 |
| 44 | −1054.0996 | 7.9200 | | | |
| 45 | 1676.5876 | 6.3800 | 1.72916 | 54.68 | 0.54451 |
| 46 | −58.7491 | 0.1200 | | | |
| 47 | −788.2525 | 5.5000 | 1.95375 | 32.32 | 0.59015 |
| 48 | 37.8837 | 1.2100 | | | |
| 49 | 40.1643 | 14.8800 | 1.56883 | 56.36 | 0.54890 |
| 50 | −74.6440 | 0.1500 | | | |
| 51 | 56.8324 | 5.7900 | 1.48749 | 70.23 | 0.53007 |
| 52 | −93.6800 | 3.4700 | 1.95375 | 32.32 | 0.59015 |
| 53 | −539.4314 | 0.2500 | | | |
| 54 | ∞ | 1.0000 | 1.51633 | 64.14 | 0.53531 |
| 55 | ∞ | 0.0000 | | | |
| 56 | ∞ | 33.0000 | 1.60863 | 46.60 | 0.56787 |
| 57 | ∞ | 13.2000 | 1.51633 | 64.14 | 0.53531 |
| 58 | ∞ | 17.3072 | | | |

TABLE 2
Example 1 - Specifications (d-line)

| | Wide Angle End | Middle | Telephoto End |
|---|---|---|---|
| Zoom Magnification | 1.0 | 48.0 | 103.0 |
| f′ | 8.69 | 417.22 | 895.29 |
| Bf′ | 47.19 | 47.19 | 47.19 |
| FNo. | 1.76 | 2.15 | 4.63 |
| 2ω[°] | 68.6 | 1.6 | 0.8 |

TABLE 3
Example 1 - Distances with respect to Zoom

| | Wide Angle End | Middle | Telephoto End |
|---|---|---|---|
| DD[10] | 2.4775 | 181.1074 | 187.6171 |
| DD[20] | 295.1513 | 38.9769 | 3.9195 |
| DD[22] | 3.0900 | 9.7300 | 2.5900 |
| DD[29] | 1.9491 | 72.8536 | 108.5413 |

TABLE 4
Example 1 - Aspheric Coefficients

| | Surface No. | | |
|---|---|---|---|
| | 11 | 22 | 25 |
| KA | 1.0000000E+00 | 1.0000000E+00 | 1.0000000E+00 |
| A4 | 5.6023431E−07 | 1.6745016E−07 | −3.2928660E−07 |
| A6 | 5.5737260E−10 | −4.2600970E−10 | −6.3312762E−10 |
| A8 | −5.9458545E−12 | 1.1531254E−12 | 1.8433516E−12 |
| A10 | 3.2911833E−14 | −1.7585791E−15 | −3.2645155E−15 |
| A12 | −9.8784592E−17 | 1.6366241E−18 | 3.6730696E−18 |
| A14 | 1.4175173E−19 | −9.2252153E−22 | −2.6523443E−21 |
| A16 | −2.4068796E−23 | 2.9245702E−25 | 1.1923581E−24 |
| A18 | −1.6366837E−25 | −4.1873551E−29 | −3.0407546E−28 |
| A20 | 1.3060328E−28 | 8.2582942E−34 | 3.3622504E−32 |

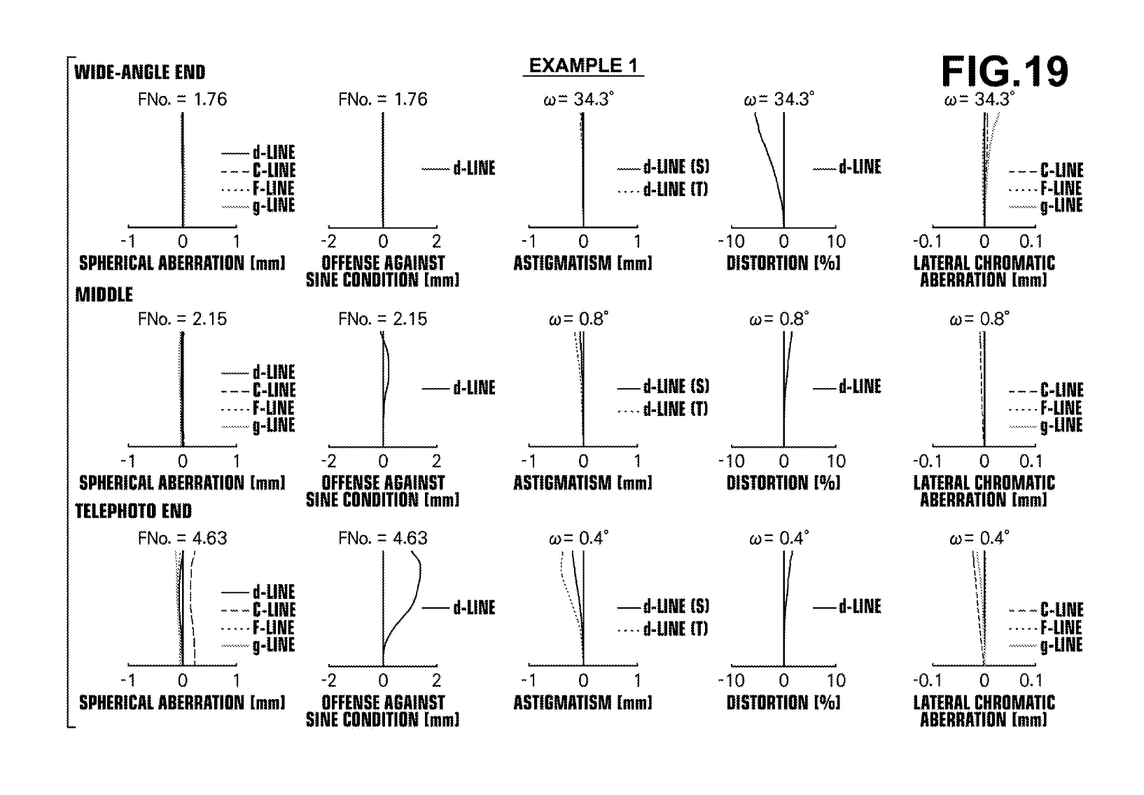

FIG. 19 shows aberration diagrams of the zoom lens of Example 1. The aberration diagrams shown at the top of FIG. 19 are those of spherical aberration, offense against the sine condition, astigmatism, distortion, and lateral chromatic aberration at the wide-angle end in this order from the left side, the aberration diagrams shown at the middle of FIG. 19 are those of spherical aberration, offense against the sine condition, astigmatism, distortion, and lateral chromatic aberration at the middle position in this order from the left side, and the aberration diagrams shown at the bottom of FIG. 19 are those of spherical aberration, offense against the sine condition, astigmatism, distortion, and lateral chromatic aberration at the telephoto end in this order from the left side. These aberration diagrams show aberrations when the object distance is infinity. The aberration diagrams of spherical aberration, offense against the sine condition, astigmatism, and distortion show those with respect to the d-line (the wavelength of 587.6 nm), which is used as a reference wavelength. The aberration diagrams of spherical aberration show those with respect to the d-line (the wavelength of 587.6 nm), the C-line (the wavelength of 656.3 nm), the F-line (the wavelength of 486.1 nm), and the g-line (the wavelength of 435.8 nm) in the solid line, the long dashed line, the short dashed line, and the gray solid line, respectively. The aberration diagrams of astigmatism show those in the sagittal direction and the tangential direction in the solid line, and the short dashed line, respectively. The aberration diagrams of lateral chromatic aberration show those with respect to the C-line (the wavelength of 656.3 nm) the F-line (the wavelength of 486.1 nm), and the g-line (the wavelength of 435.8 nm) in the long dashed line, the short dashed line, and the gray solid line, respectively. The “FNo.” in the aberration diagrams of spherical aberration and offense against the sine condition means “f-number”, and the “ω” in the other aberration diagrams means “half angle of view”.

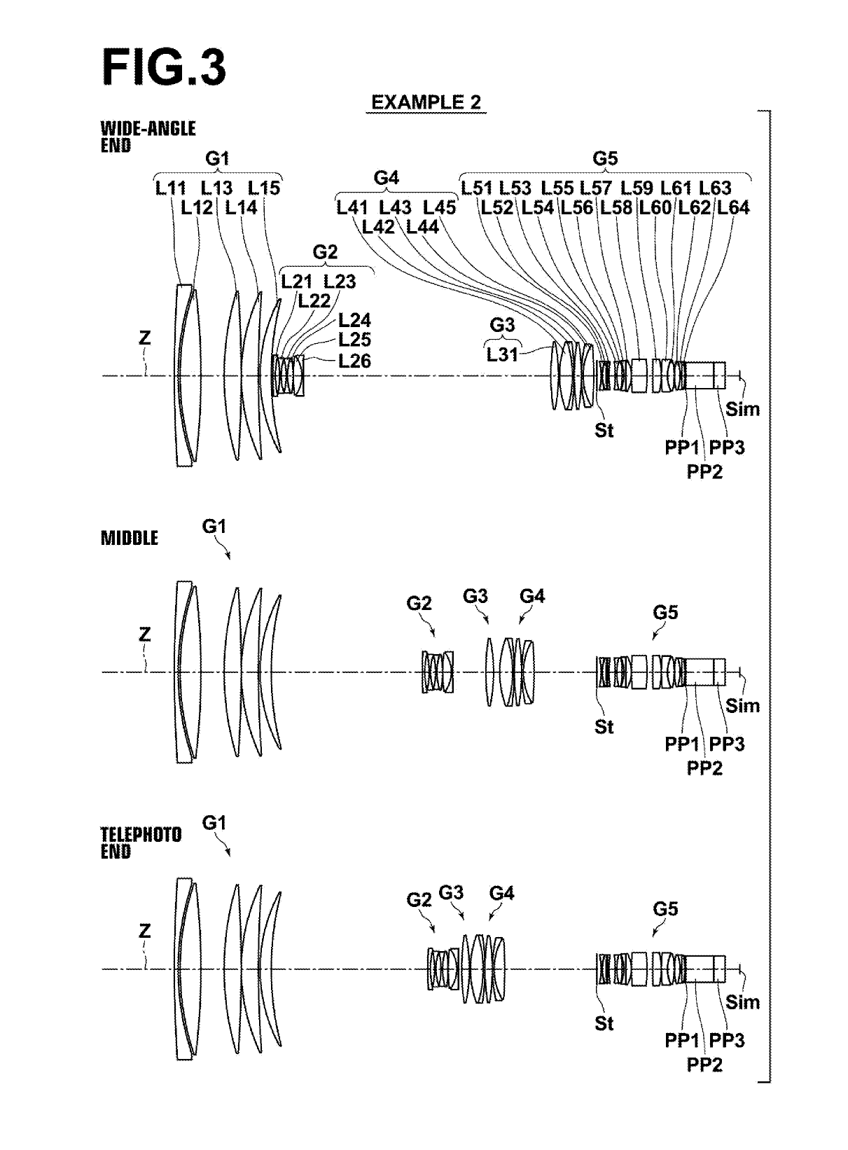

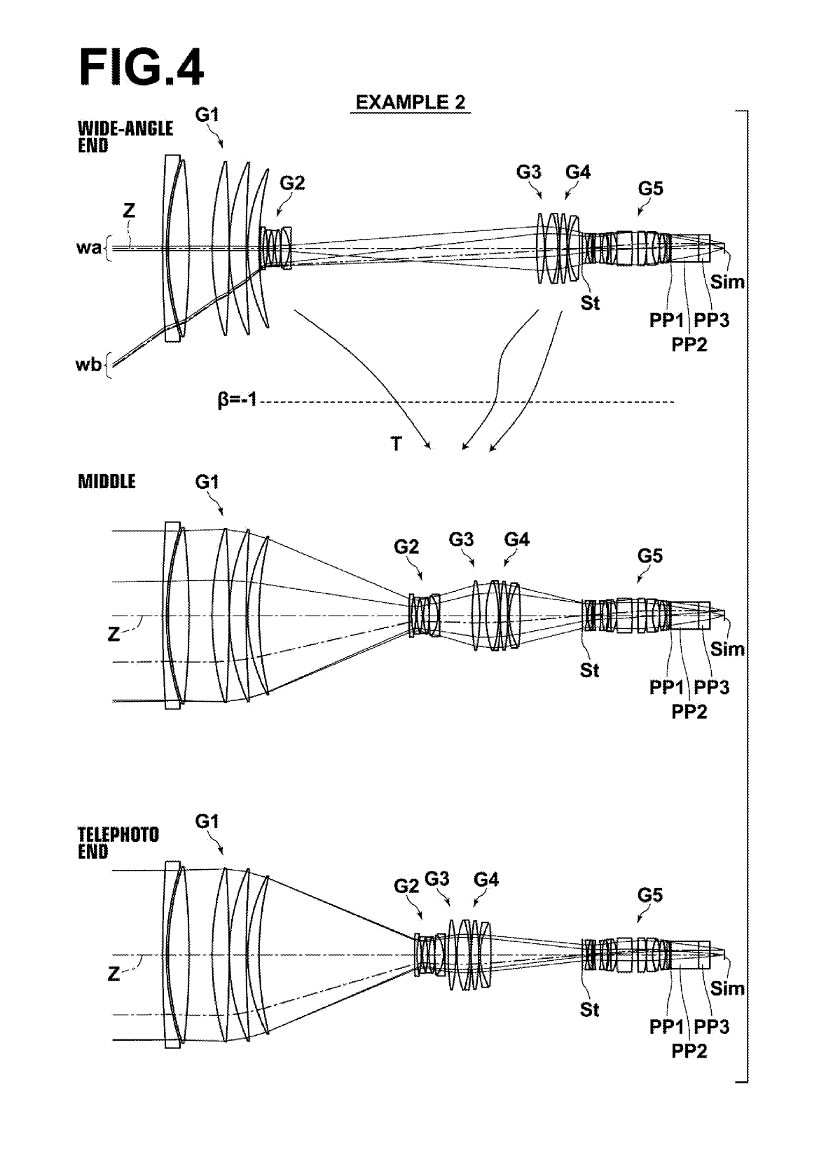

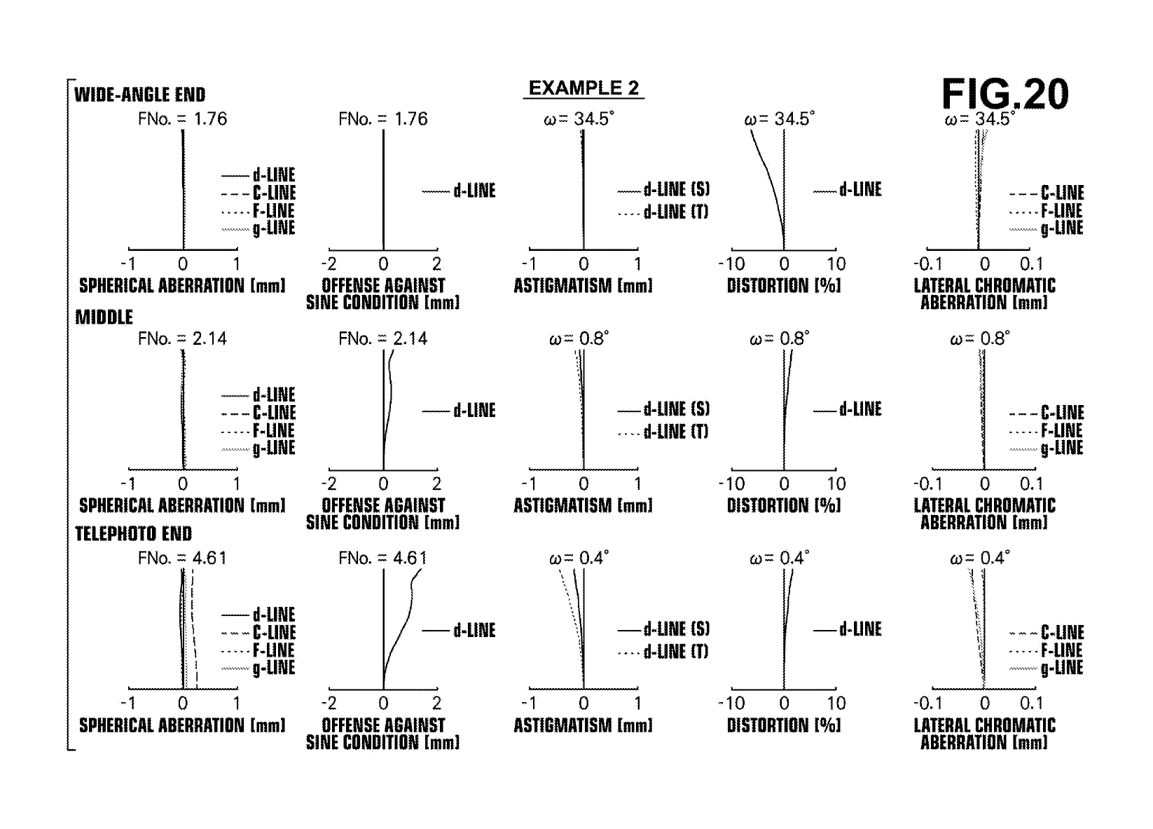

Next, a zoom lens of Example 2 is described. FIG. 3 is a sectional view illustrating the lens configuration of the zoom lens of Example 2, and FIG. 4 is a diagram showing optical paths through the zoom lens. The zoom lens of Example 2 differs from the zoom lens of Example 1 in that, in the zoom lens of Example 2, the fourth lens group G4 is formed by five lenses, i.e., lenses L41 to L45, and the fifth lens group G5 is formed by fourteen lenses, i.e., lenses L51 to L64. Table 5 shows basic lens data of the zoom lens of Example 2, Table 6 shows data about specifications of the zoom lens, Table 7 shows data about surface distances to be changed of the zoom lens, Table 8 shows data about aspheric coefficients of the zoom lens, and FIG. 20 shows aberration diagrams of the zoom lens.

TABLE 5
Example 2 - Lens Data

| Surface | Radius of | Surface | | | |
|---|---|---|---|---|---|
| No. | Curvature | Distance | nd | νd | θg, F |
| 1 | 1621.8264 | 4.4000 | 1.83400 | 37.34 | 0.57908 |
| 2 | 321.1166 | 2.3074 | | | |
| 3 | 319.8571 | 24.6282 | 1.43387 | 95.20 | 0.53733 |
| 4 | −846.0399 | 27.3529 | | | |
| 5 | 351.3661 | 20.0650 | 1.43387 | 95.20 | 0.53733 |
| 6 | −1402.9128 | 0.1200 | | | |
| 7 | 233.6545 | 20.0438 | 1.43387 | 95.20 | 0.53733 |
| 8 | 1255.5213 | 2.0341 | | | |
| 9 | 192.7395 | 13.1724 | 1.43875 | 94.93 | 0.53433 |
| 10 | 363.0563 | DD[10] | | | |
| *11 | −2777777.9346 | 2.8000 | 1.90366 | 31.32 | 0.59481 |
| 12 | 98.7837 | 4.9567 | | | |
| 13 | −102.1714 | 1.7000 | 2.00100 | 29.13 | 0.59952 |
| 14 | 66.3514 | 5.8916 | | | |
| 15 | −81.8572 | 1.7000 | 1.95375 | 32.32 | 0.59015 |
| 16 | 72.4934 | 6.6056 | 1.80809 | 22.76 | 0.63073 |
| 17 | −121.1396 | 0.1200 | | | |
| 18 | 188.8503 | 10.2510 | 1.80809 | 22.76 | 0.63073 |
| 19 | −39.5623 | 1.7000 | 1.81600 | 46.62 | 0.55682 |
| 20 | 753.8351 | DD[20] | | | |
| 21 | 268.1342 | 9.0636 | 1.59282 | 68.63 | 0.54414 |
| *22 | −186.9580 | DD[22] | | | |
| 23 | 116.3677 | 15.0601 | 1.43875 | 94.93 | 0.53433 |
| 24 | −135.2846 | 2.0000 | 1.59270 | 35.31 | 0.59336 |
| 25 | −288.4689 | 0.1200 | | | |
| *26 | 210.0268 | 8.6054 | 1.43875 | 94.93 | 0.53433 |
| 27 | −250.1556 | 0.1200 | | | |
| 28 | 168.6619 | 2.0000 | 1.80000 | 29.84 | 0.60178 |
| 29 | 73.2023 | 12.5372 | 1.43875 | 94.93 | 0.53433 |
| 30 | −456.7046 | DD[30] | | | |
| 31 (stop) | ∞ | 5.0115 | | | |
| 32 | −84.0203 | 1.5000 | 1.77250 | 49.60 | 0.55212 |
| 33 | 61.9110 | 0.1200 | | | |
| 34 | 46.2228 | 4.5175 | 1.80518 | 25.42 | 0.61616 |
| 35 | 211.3971 | 1.8300 | | | |
| 36 | −177.3816 | 1.5000 | 1.48749 | 70.23 | 0.53007 |
| 37 | 125.6004 | 7.2756 | | | |
| 38 | −114.0392 | 1.8000 | 1.80400 | 46.58 | 0.55730 |
| 39 | 63.0729 | 6.2400 | 1.80518 | 25.43 | 0.61027 |
| 40 | −105.3906 | 1.9324 | | | |
| 41 | −46.7551 | 2.1750 | 2.00100 | 29.13 | 0.59952 |
| 42 | 492.1494 | 6.8481 | 1.51823 | 58.90 | 0.54567 |
| 43 | −38.0880 | 0.1200 | | | |
| 44 | 344.0131 | 18.2262 | 1.59270 | 35.31 | 0.59336 |
| 45 | −192.6033 | 6.7109 | | | |
| 46 | 654.7236 | 9.9919 | 1.68893 | 31.07 | 0.60041 |
| 47 | −87.5160 | 0.1200 | | | |
| 48 | 201.4706 | 7.2349 | 1.91082 | 35.25 | 0.58224 |
| 49 | 45.5310 | 0.1910 | | | |
| 50 | 42.6154 | 7.8868 | 1.51742 | 52.43 | 0.55649 |
| 51 | −76.2445 | 0.1200 | | | |
| 52 | 70.9272 | 6.7891 | 1.48749 | 70.23 | 0.53007 |
| 53 | −49.5244 | 1.8295 | 2.00100 | 29.13 | 0.59952 |
| 54 | −10986903.2517 | 3.5616 | 1.51823 | 58.90 | 0.54567 |
| 55 | −79.2918 | 0.2498 | | | |
| 56 | ∞ | 1.0000 | 1.51633 | 64.14 | 0.53531 |
| 57 | ∞ | 0.0000 | | | |
| 58 | ∞ | 33.0000 | 1.60863 | 46.60 | 0.56787 |
| 59 | ∞ | 13.2000 | 1.51633 | 64.14 | 0.53531 |
| 60 | ∞ | 17.3478 | | | |

TABLE 6
Example 2 − Specifications (d-line)

| | Wide Angle End | Middle | Telephoto End |
|---|---|---|---|
| Zoom Magnification | 1.0 | 48.0 | 103.0 |
| f′ | 8.70 | 417.36 | 895.60 |
| Bf′ | 47.48 | 47.48 | 47.48 |
| FNo. | 1.76 | 2.14 | 4.61 |
| 2ω[°] | 69.0 | 1.6 | 0.8 |

TABLE 7
Example 2 - Distances with respect to Zoom

| | Wide Angle End | Middle | Telephoto End |
|---|---|---|---|
| DD[10] | 2.1062 | 178.0467 | 184.5595 |
| DD[20] | 291.3621 | 38.9988 | 3.9233 |
| DD[22] | 1.2197 | 7.1626 | 1.2218 |
| DD[30] | 3.5802 | 74.0602 | 108.5638 |

TABLE 8
Example 2 - Aspheric Coefficients

| | Surface No. | | |
|---|---|---|---|
| | 11 | 22 | 26 |
| KA | 1.0000000E+00 | 1.0000000E+00 | 1.0000000E+00 |
| A4 | 1.3617401E−06 | 6.8856999E−08 | −2.8066697E−07 |
| A6 | 2.1211905E−11 | 5.4670539E−12 | −3.1663334E−12 |
| A8 | −8.7707146E−14 | 4.8525628E−15 | 4.6640532E−15 |
| A10 | 4.1075859E−16 | −1.8961447E−18 | −1.6978421E−18 |

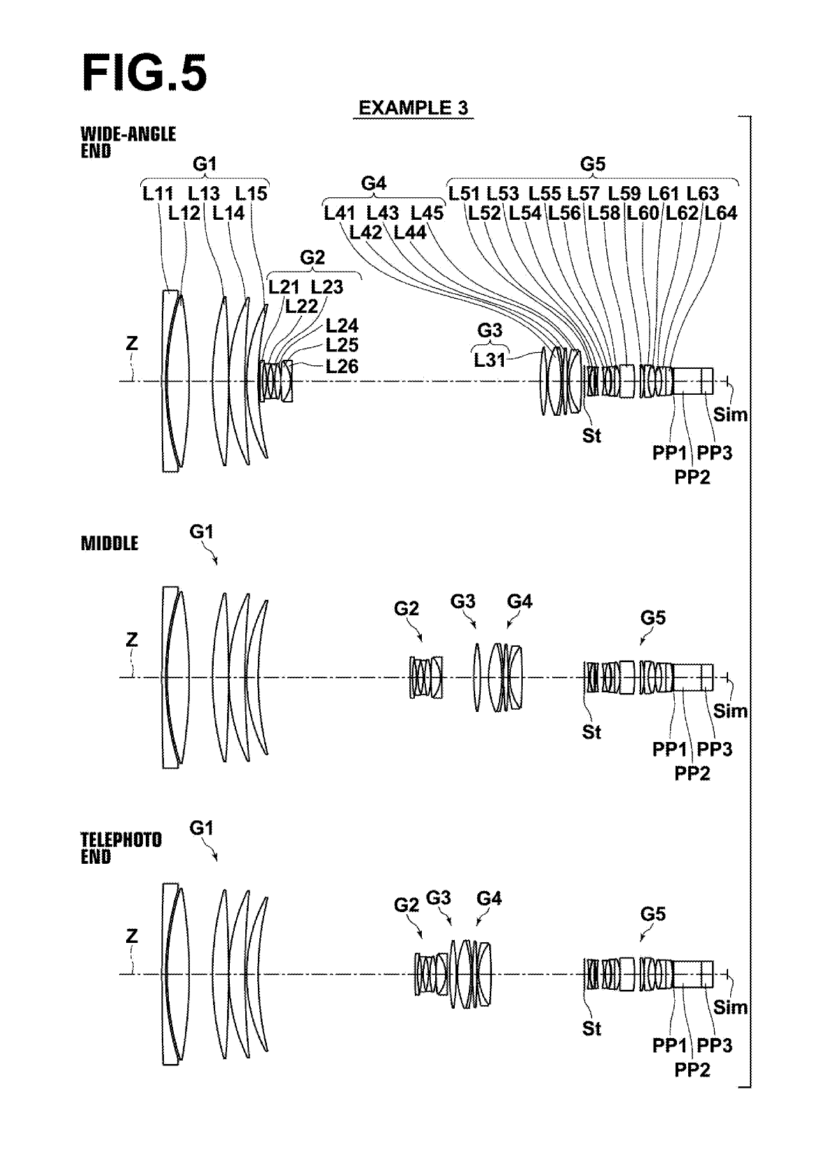

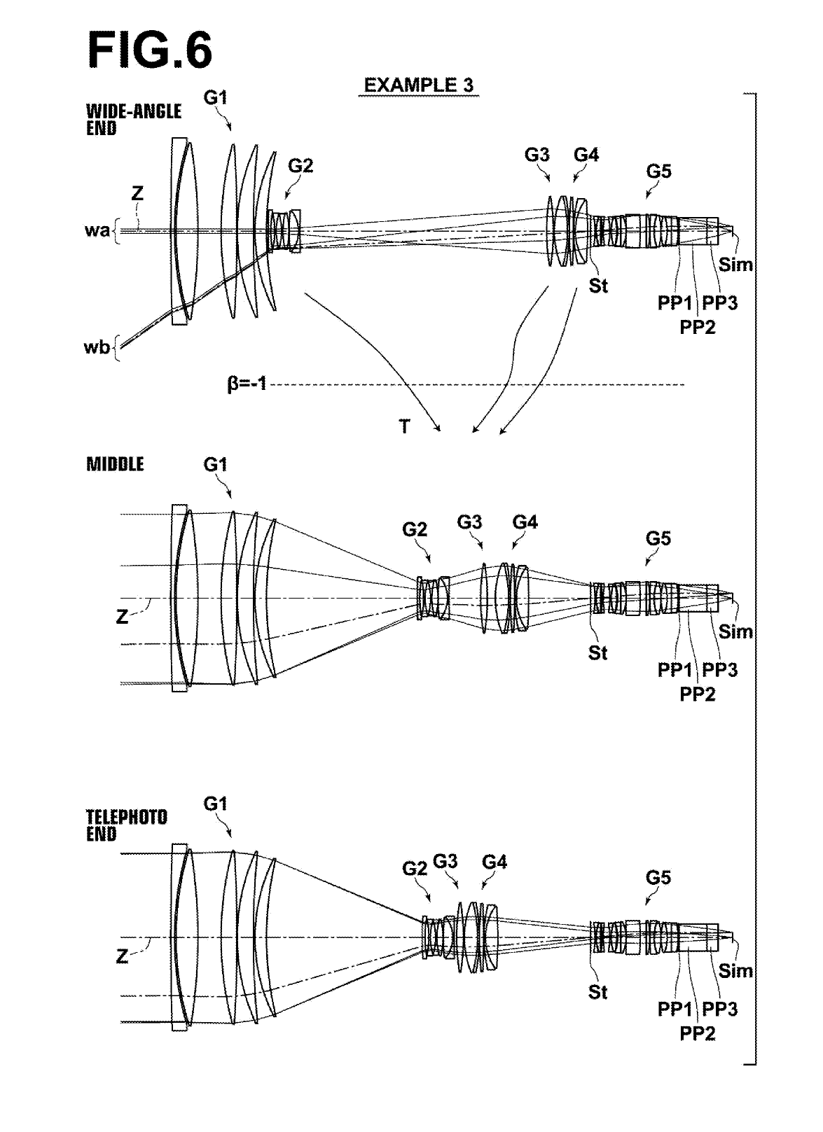

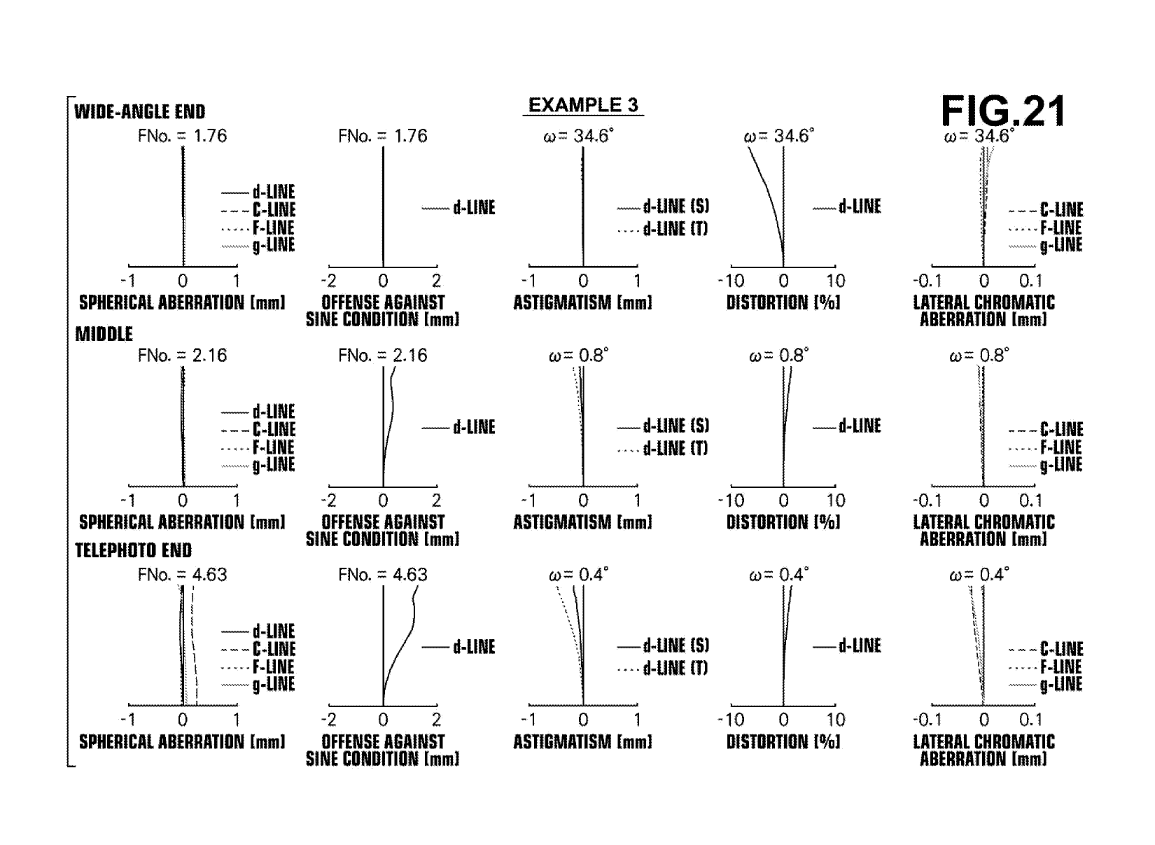

Next, a zoom lens of Example 3 is described. FIG. 5 is a sectional view illustrating the lens configuration of the zoom lens of Example 3, and FIG. 6 is a diagram showing optical paths through the zoom lens. The zoom lens of Example 3 is formed by the same number of lenses as the zoom lens of Example 2. Table 9 shows basic lens data of the zoom lens of Example 3, Table 10 shows data about specifications of the zoom lens, Table 11 shows data about surface distances to be changed of the zoom lens, Table 12 shows data about aspheric coefficients of the zoom lens, and FIG. 21 shows aberration diagrams of the zoom lens.

TABLE 9
Example 3 - Lens Data

| | Radius of | | | | |
|---|---|---|---|---|---|
| Surface No. | Curvature | Surface Distance | nd | νd | θg, F |
| 1 | 3401.6455 | 4.4000 | 1.83400 | 37.16 | 0.57759 |
| 2 | 351.0096 | 1.8868 | | | |
| 3 | 342.2938 | 25.8399 | 1.43387 | 95.20 | 0.53733 |
| 4 | −617.1126 | 27.5208 | | | |
| 5 | 376.1863 | 18.8689 | 1.43387 | 95.20 | 0.53733 |
| 6 | −1480.7062 | 0.1200 | | | |
| 7 | 231.2856 | 19.2460 | 1.43387 | 95.20 | 0.53733 |
| 8 | 989.5463 | 2.0149 | | | |
| 9 | 197.6466 | 13.4721 | 1.49700 | 81.54 | 0.53748 |
| 10 | 375.6095 | DD[10] | | | |
| *11 | ∞ | 3.0000 | 2.00069 | 25.46 | 0.61364 |
| 12 | 117.2892 | 4.6982 | | | |
| 13 | −94.1530 | 1.7000 | 2.00100 | 29.13 | 0.59952 |
| 14 | 62.7238 | 6.3333 | | | |
| 15 | −68.8577 | 1.7000 | 2.00100 | 29.13 | 0.59952 |
| 16 | 82.7458 | 7.1864 | 1.80809 | 22.76 | 0.63073 |
| 17 | −83.6047 | 0.1200 | | | |
| 18 | 203.1800 | 11.2541 | 1.80809 | 22.76 | 0.63073 |
| 19 | −36.9251 | 1.7000 | 1.81600 | 46.62 | 0.55682 |
| 20 | 1365.5915 | DD[20] | | | |
| 21 | 241.0954 | 7.8946 | 1.59282 | 68.63 | 0.54414 |
| *22 | −241.6904 | DD[22] | | | |
| 23 | 103.8609 | 15.7378 | 1.43875 | 94.93 | 0.53433 |
| 24 | −143.9534 | 2.0000 | 1.59270 | 35.31 | 0.59336 |
| 25 | −204.8217 | 0.1201 | | | |
| *26 | 288.8799 | 5.1397 | 1.43875 | 94.93 | 0.53433 |
| 27 | −602.9309 | 0.1200 | | | |
| 28 | 148.1149 | 2.0000 | 1.71736 | 29.52 | 0.60483 |
| 29 | 61.8772 | 14.4753 | 1.43875 | 94.93 | 0.53433 |
| 30 | −435.0225 | DD[30] | | | |
| 31 (stop) | ∞ | 5.1564 | | | |
| 32 | −110.6957 | 1.5000 | 1.77250 | 49.60 | 0.55212 |
| 33 | 56.7314 | 0.1198 | | | |
| 34 | 44.3333 | 4.8711 | 1.80518 | 25.42 | 0.61616 |
| 35 | 303.5707 | 1.8584 | | | |
| 36 | −109.1693 | 1.5000 | 1.48749 | 70.23 | 0.53007 |
| 37 | 112.1803 | 7.6633 | | | |
| 38 | −86.9018 | 1.8000 | 1.80400 | 46.58 | 0.55730 |
| 39 | 53.6132 | 6.4361 | 1.80518 | 25.43 | 0.61027 |
| 40 | −72.8379 | 1.2686 | | | |
| 41 | −46.5273 | 3.3491 | 2.00069 | 25.46 | 0.61364 |
| 42 | 801.7665 | 6.5335 | 1.51633 | 64.14 | 0.53531 |
| 43 | −41.5451 | 0.1200 | | | |
| 44 | −624.9701 | 16.7392 | 1.59270 | 35.31 | 0.59336 |
| 45 | −160.0078 | 7.1806 | | | |
| 46 | −556.3538 | 4.1093 | 1.76182 | 26.52 | 0.61361 |
| 47 | −78.7616 | 0.1250 | | | |
| 48 | 281.5288 | 4.7676 | 1.88300 | 40.76 | 0.56679 |
| 49 | 51.2333 | 0.1377 | | | |
| 50 | 46.8988 | 8.1690 | 1.51633 | 64.14 | 0.53531 |
| 51 | −67.6554 | 0.1198 | | | |
| 52 | 65.7102 | 7.2583 | 1.48749 | 70.23 | 0.53007 |
| 53 | −49.7664 | 5.0000 | 2.00100 | 29.13 | 0.59952 |
| 54 | 1098.4109 | 7.7546 | 1.51633 | 64.14 | 0.53531 |
| 55 | −77.0153 | 0.2498 | | | |
| 56 | ∞ | 1.0000 | 1.51633 | 64.14 | 0.53531 |
| 57 | ∞ | 0.0000 | | | |
| 58 | ∞ | 33.0000 | 1.60863 | 46.60 | 0.56787 |
| 59 | ∞ | 13.2000 | 1.51633 | 64.14 | 0.53531 |
| 60 | ∞ | 17.3402 | | | |

TABLE 10
Example 3 - Specifications (d-line)

| | Wide Angle End | Middle | Telephoto End |
|---|---|---|---|
| Zoom Magnification | 1.0 | 48.0 | 103.0 |
| f′ | 8.69 | 417.11 | 895.06 |
| Bf′ | 47.47 | 47.47 | 47.47 |
| FNo. | 1.76 | 2.16 | 4.63 |
| 2ω [°] | 69.2 | 1.6 | 0.8 |

TABLE 11
Example 3 - Distances with respect to Zoom

| | Wide Angle End | Middle | Telephoto End |
|---|---|---|---|
| DD[10] | 2.0564 | 178.6194 | 184.7805 |
| DD[20] | 292.3116 | 37.5494 | 2.9266 |
| DD[22] | 1.1659 | 9.3749 | 1.1694 |
| DD[30] | 3.5498 | 73.5399 | 110.2071 |

TABLE 12
Example 3 - Aspheric Coefficients

| | Surface No. | | |
|---|---|---|---|
| | 11 | 22 | 26 |
| KA | 1.0000000E+00 | 1.0000000E+00 | 1.0000000E+00 |
| A4 | 1.5986805E−06 | 6.3959084E−08 | −3.0646162E−07 |
| A6 | 6.2257478E−11 | 3.1977885E−12 | −6.8530435E−12 |
| A8 | −1.1157694E−13 | 6.8145266E−15 | 5.0409987E−15 |
| A10 | 5.4339717E−16 | −2.4409123E−18 | −1.8612932E−18 |

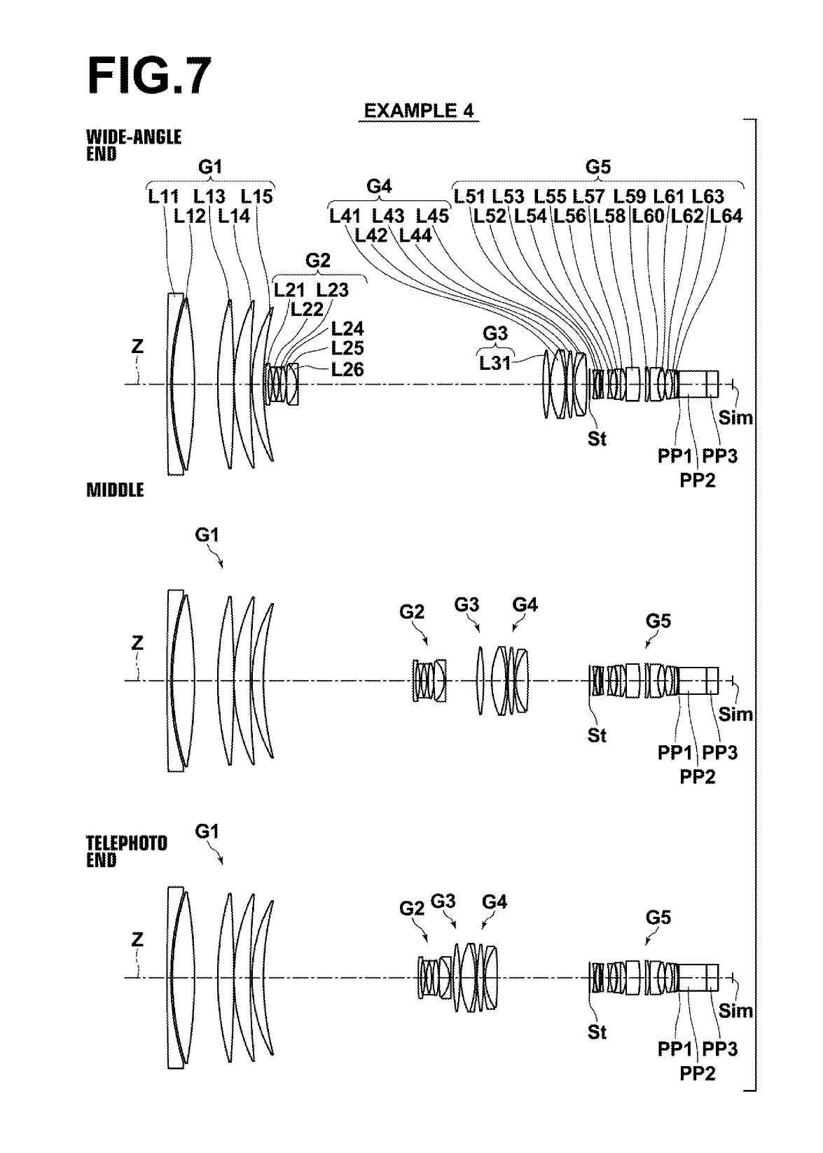

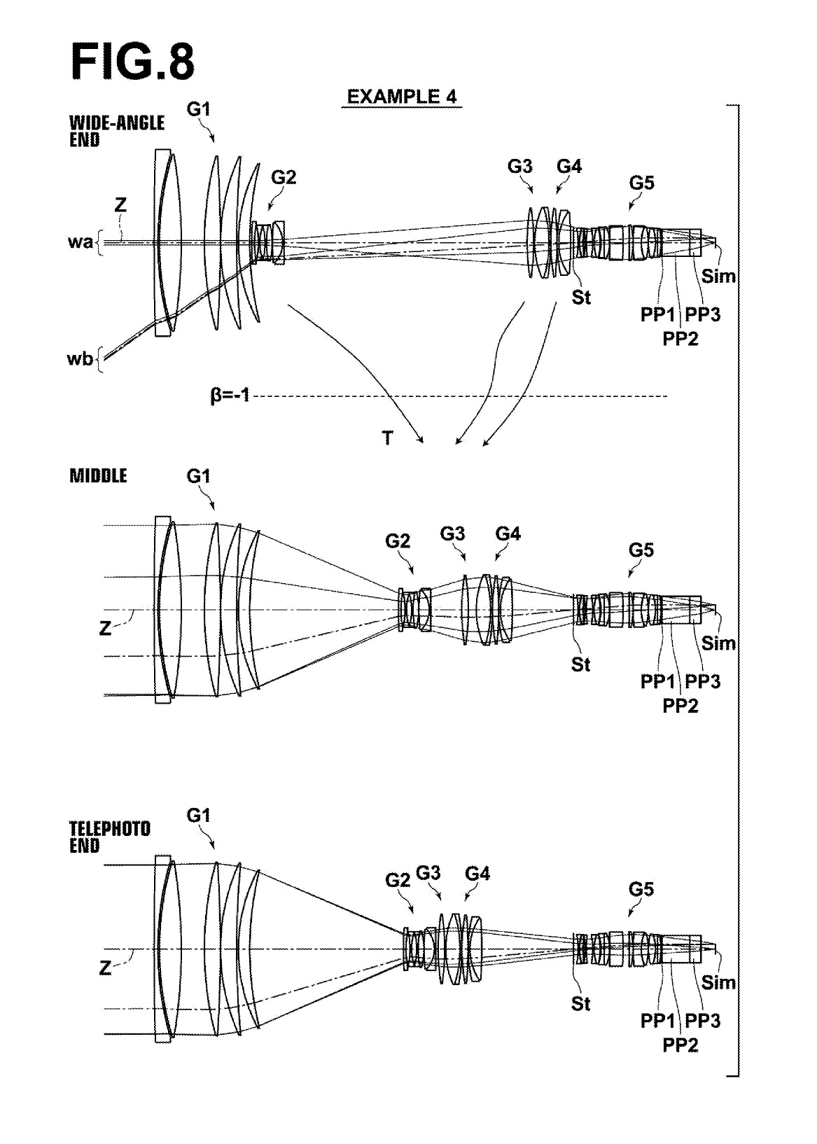

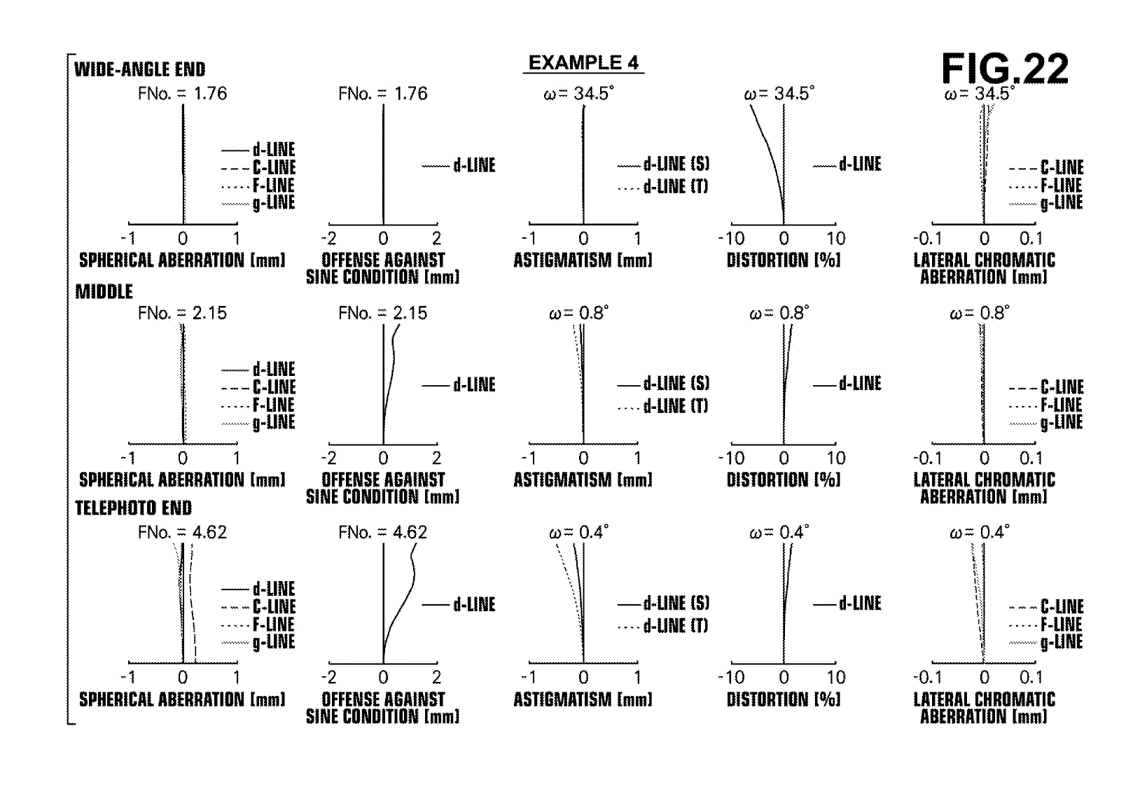

Next, a zoom lens of Example 4 is described. FIG. 7 is a sectional view illustrating the lens configuration of the zoom lens of Example 4, and FIG. 8 is a diagram showing optical paths through the zoom lens. The zoom lens of Example 4 is formed by the same number of lenses as the zoom lens of Example 2. Table 13 shows basic lens data of the zoom lens of Example 4, Table 14 shows data about specifications of the zoom lens, Table 15 shows data about surface distances to be changed of the zoom lens, Table 16 shows data about aspheric coefficients of the zoom lens, and FIG. 22 shows aberration diagrams of the zoom lens.

TABLE 13
Example 4 - Lens Data

| | Radius of | | | | |
|---|---|---|---|---|---|
| Surface No. | Curvature | Surface Distance | nd | νd | θg, F |
| 1 | 3987.0357 | 4.4000 | 1.83400 | 37.16 | 0.57759 |
| 2 | 353.1677 | 1.8868 | | | |
| 3 | 343.7377 | 25.8399 | 1.43387 | 95.20 | 0.53733 |
| 4 | −600.0703 | 27.5208 | | | |
| 5 | 377.0135 | 18.8689 | 1.43387 | 95.20 | 0.53733 |
| 6 | −1427.2777 | 0.1200 | | | |
| 7 | 232.5651 | 19.2460 | 1.43387 | 95.20 | 0.53733 |
| 8 | 1032.3959 | 2.0149 | | | |
| 9 | 190.7154 | 13.4721 | 1.49700 | 81.54 | 0.53748 |
| 10 | 363.3054 | DD[10] | | | |
| *11 | ∞ | 3.0000 | 2.00069 | 25.46 | 0.61364 |
| 12 | 109.9598 | 4.7781 | | | |
| 13 | −86.4093 | 1.7000 | 2.00100 | 29.13 | 0.59952 |
| 14 | 60.8206 | 6.1620 | | | |
| 15 | −67.0110 | 1.7000 | 2.00100 | 29.13 | 0.59952 |
| 16 | 99.6297 | 6.8701 | 1.80809 | 22.76 | 0.63073 |
| 17 | −77.3020 | 0.1202 | | | |
| 18 | 211.9794 | 12.1921 | 1.80809 | 22.76 | 0.63073 |
| 19 | −33.5155 | 1.7000 | 1.83481 | 42.73 | 0.56486 |
| 20 | −3739.2878 | DD[20] | | | |
| 21 | 245.2840 | 7.7949 | 1.59282 | 68.63 | 0.54414 |
| *22 | −242.6299 | DD[22] | | | |
| 23 | 98.6538 | 17.0946 | 1.43875 | 94.93 | 0.53433 |
| 24 | −129.2951 | 2.0000 | 1.59270 | 35.31 | 0.59336 |
| 25 | −232.6237 | 0.1201 | | | |
| *26 | 177.7072 | 7.3589 | 1.43875 | 94.93 | 0.53433 |
| 27 | −392.0255 | 0.1200 | | | |
| 28 | 152.2737 | 2.0000 | 1.80610 | 33.27 | 0.58845 |
| 29 | 62.6647 | 14.1273 | 1.43875 | 94.93 | 0.53433 |
| 30 | −437.9227 | DD[30] | | | |
| 31 (stop) | ∞ | 5.2201 | | | |
| 32 | −101.8698 | 1.5000 | 1.77250 | 49.60 | 0.55212 |
| 33 | 58.9475 | 0.1198 | | | |
| 34 | 45.0327 | 4.4319 | 1.80518 | 25.42 | 0.61616 |
| 35 | 187.8627 | 2.1344 | | | |
| 36 | −103.3506 | 1.5000 | 1.48749 | 70.23 | 0.53007 |
| 37 | 102.5090 | 7.6689 | | | |
| 38 | −92.2208 | 1.8000 | 1.80400 | 46.58 | 0.55730 |
| 39 | 53.4800 | 7.1105 | 1.80518 | 25.43 | 0.61027 |
| 40 | −70.0090 | 1.2248 | | | |
| 41 | −46.5357 | 3.4999 | 2.00069 | 25.46 | 0.61364 |
| 42 | 853.2807 | 6.5996 | 1.51633 | 64.14 | 0.53531 |
| 43 | −41.9580 | 0.1200 | | | |
| 44 | −1519.5243 | 15.9644 | 1.59270 | 35.31 | 0.59336 |
| 45 | −158.9375 | 7.1691 | | | |
| 46 | −495.7287 | 4.4353 | 1.76182 | 26.52 | 0.61361 |
| 47 | −81.0614 | 0.1252 | | | |
| 48 | 227.7152 | 9.6335 | 1.88300 | 40.76 | 0.56679 |
| 49 | 52.1877 | 0.1248 | | | |
| 50 | 46.3121 | 8.1613 | 1.51633 | 64.14 | 0.53531 |
| 51 | −70.4373 | 0.1198 | | | |
| 52 | 64.0581 | 8.3921 | 1.48749 | 70.23 | 0.53007 |
| 53 | −50.1528 | 2.3091 | 2.00100 | 29.13 | 0.59952 |
| 54 | 461.9674 | 4.1378 | 1.51633 | 64.14 | 0.53531 |
| 55 | −81.3407 | 0.2498 | | | |
| 56 | ∞ | 1.0000 | 1.51633 | 64.14 | 0.53531 |
| 57 | ∞ | 0.0000 | | | |
| 58 | ∞ | 33.0000 | 1.60863 | 46.60 | 0.56787 |
| 59 | ∞ | 13.2000 | 1.51633 | 64.14 | 0.53531 |
| 60 | ∞ | 17.3349 | | | |

TABLE 14
Example 4 - Specifications (d-line)

| | Wide Angle End | Middle | Telephoto End |
|---|---|---|---|
| Zoom Magnification | 1.0 | 48.0 | 103.0 |
| f′ | 8.69 | 417.07 | 894.96 |
| Bf′ | 47.46 | 47.46 | 47.46 |
| FNo. | 1.76 | 2.15 | 4.62 |
| 2ω [°] | 69.0 | 1.6 | 0.8 |

TABLE 15
Example 4 - Distances with respect to Zoom

| | Wide Angle End | Middle | Telephoto End |
|---|---|---|---|
| DD[10] | 2.5703 | 176.3673 | 182.4081 |
| DD[20] | 288.2875 | 36.9367 | 2.8736 |
| DD[22] | 1.1146 | 9.3236 | 1.1181 |
| DD[30] | 3.5225 | 72.8673 | 109.0952 |

TABLE 16
Example 4 - Aspheric Coefficients

| | Surface No. | | |
|---|---|---|---|
| | 11 | 22 | 26 |
| KA | 1.0000000E+00 | 1.0000000E+00 | 1.0000000E+00 |
| A4 | 1.8116407E−06 | 5.7079490E−08 | −3.6373275E−07 |
| A6 | 8.9293870E−11 | 8.4712262E−12 | −5.3119700E−12 |
| A8 | −9.6769912E−14 | 5.3128698E−15 | 2.7758261E−15 |
| A10 | 6.9368360E−16 | −2.3597980E−18 | −1.5135427E−18 |

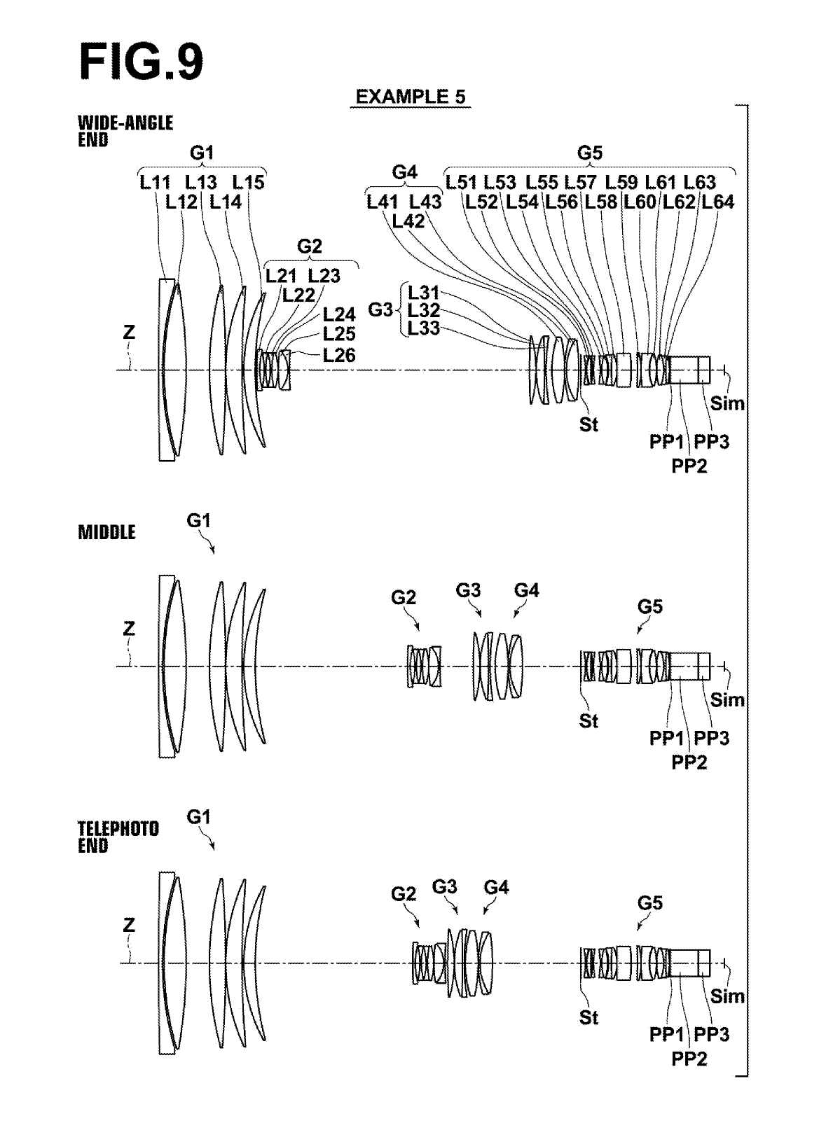

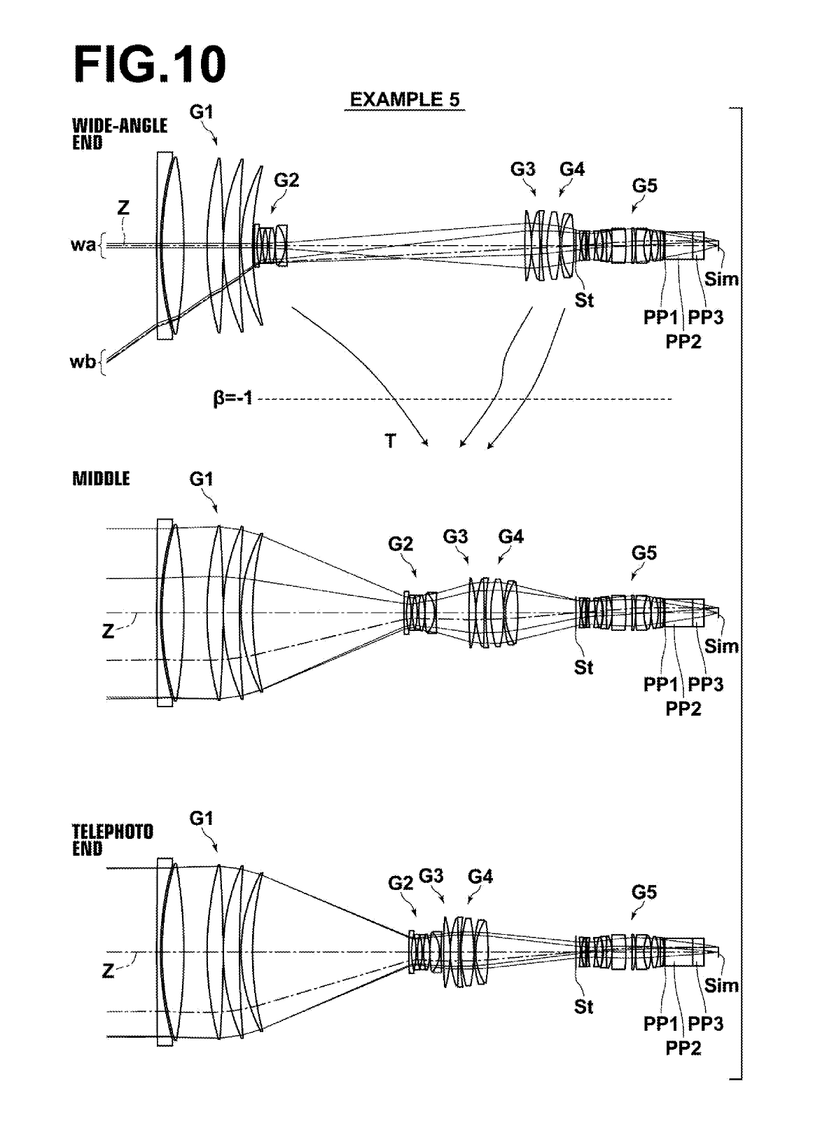

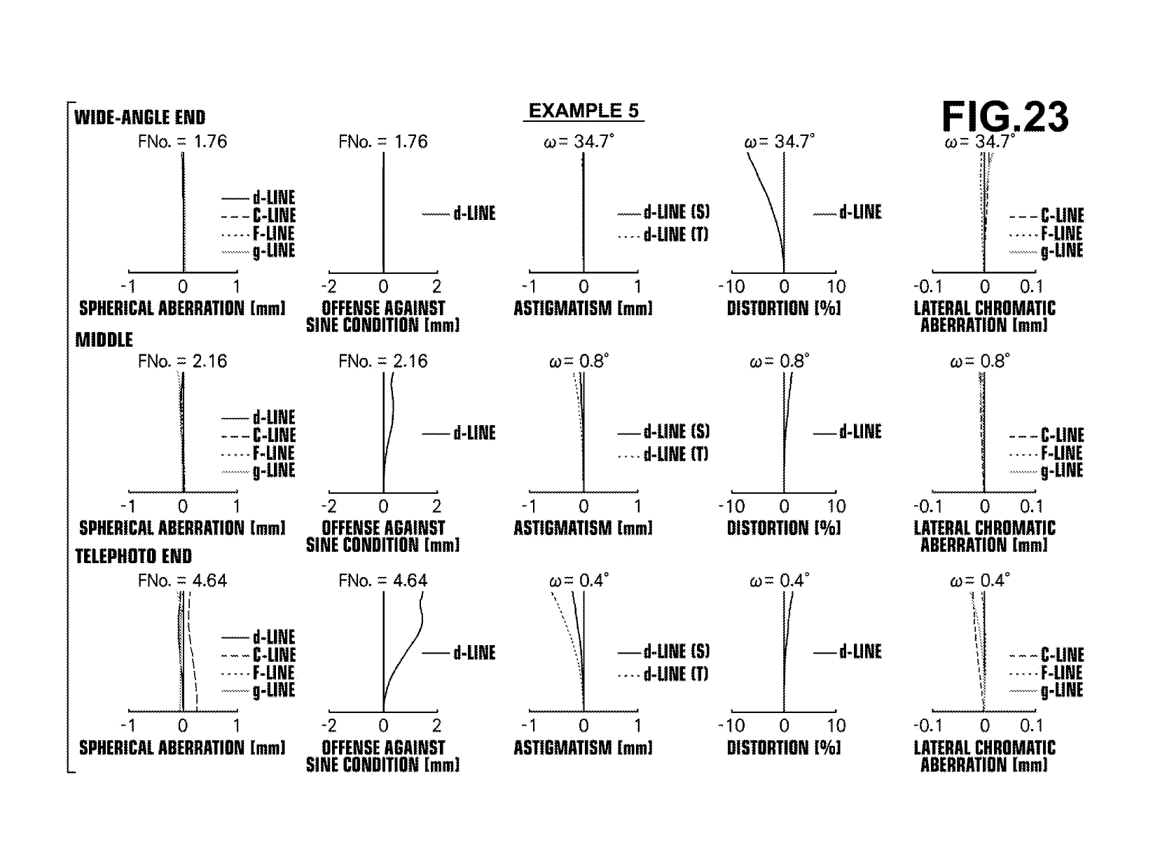

Next, a zoom lens of Example 5 is described. FIG. 9 is a sectional view illustrating the lens configuration of the zoom lens of Example 5, and FIG. 10 is a diagram showing optical paths through the zoom lens. The zoom lens of Example 5 differs from the zoom lens of Example 2 in that, in the zoom lens of Example 5, the third lens group G3 is formed by three lenses, i.e., lenses L31 to L33, and the fourth lens group G4 is formed by three lenses, i.e., lenses L41 to L43. Table 17 shows basic lens data of the zoom lens of Example 5, Table 18 shows data about specifications of the zoom lens, Table 19 shows data about surface distances to be changed of the zoom lens, Table 20 shows data about aspheric coefficients of the zoom lens, and FIG. 23 shows aberration diagrams of the zoom lens.

TABLE 17
Example 5 - Lens Data

| | Radius of | | | | |
|---|---|---|---|---|---|
| Surface No. | Curvature | Surface Distance | nd | νd | θg, F |
| 1 | 6979.0358 | 4.4000 | 1.83400 | 37.16 | 0.57759 |
| 2 | 361.3278 | 1.8868 | | | |
| 3 | 350.6223 | 25.8399 | 1.43387 | 95.20 | 0.53733 |
| 4 | −584.8124 | 27.5208 | | | |
| 5 | 386.8086 | 18.8689 | 1.43387 | 95.20 | 0.53733 |
| 6 | −1291.2649 | 0.1200 | | | |
| 7 | 237.4752 | 19.2460 | 1.43387 | 95.20 | 0.53733 |
| 8 | 1163.7767 | 2.0149 | | | |
| 9 | 189.3873 | 13.4721 | 1.49700 | 81.54 | 0.53748 |
| 10 | 354.9406 | DD[10] | | | |
| *11 | ∞ | 3.0000 | 1.90366 | 31.32 | 0.59481 |
| 12 | 81.4565 | 5.4302 | | | |
| 13 | −87.5993 | 1.7000 | 2.00100 | 29.13 | 0.59952 |
| 14 | 81.5555 | 5.5072 | | | |
| 15 | −68.9623 | 1.7000 | 2.00100 | 29.13 | 0.59952 |
| 16 | 91.5134 | 7.3631 | 1.80809 | 22.76 | 0.63073 |
| 17 | −71.3250 | 0.1484 | | | |
| 18 | 143.1363 | 11.4349 | 1.80809 | 22.76 | 0.63073 |
| 19 | −35.8094 | 1.7000 | 1.88300 | 40.76 | 0.56679 |
| 20 | 325.8952 | DD[20] | | | |
| 21 | 629.3569 | 7.8153 | 1.59282 | 68.63 | 0.54414 |
| *22 | −144.9999 | 0.1200 | | | |
| 23 | 110.7548 | 9.7232 | 1.43875 | 94.93 | 0.53433 |
| 24 | −954.5669 | 2.0000 | 1.59270 | 35.31 | 0.59336 |
| 25 | 259.2839 | DD[25] | | | |
| *26 | 119.9299 | 15.1215 | 1.43875 | 94.93 | 0.53433 |
| 27 | −187.9074 | 0.1201 | | | |
| 28 | 131.8988 | 2.0000 | 1.80000 | 29.84 | 0.60178 |
| 29 | 67.6155 | 14.6824 | 1.43875 | 94.93 | 0.53433 |
| 30 | −244.5287 | DD[30] | | | |
| 31 (stop) | ∞ | 5.1723 | | | |
| 32 | −102.3335 | 1.5000 | 1.77250 | 49.60 | 0.55212 |
| 33 | 59.4127 | 0.1198 | | | |
| 34 | 44.8915 | 4.5220 | 1.80518 | 25.42 | 0.61616 |
| 35 | 207.0999 | 2.0524 | | | |
| 36 | −104.6229 | 1.5000 | 1.48749 | 70.23 | 0.53007 |
| 37 | 102.8295 | 7.7469 | | | |
| 38 | −92.3741 | 1.8000 | 1.80400 | 46.58 | 0.55730 |
| 39 | 54.3270 | 6.8091 | 1.80518 | 25.43 | 0.61027 |
| 40 | −70.1486 | 1.2530 | | | |
| 41 | −46.5200 | 3.4514 | 2.00069 | 25.46 | 0.61364 |
| 42 | 859.6076 | 6.5702 | 1.51633 | 64.14 | 0.53531 |
| 43 | −41.9951 | 0.1200 | | | |
| 44 | −1480.4554 | 16.3196 | 1.59270 | 35.31 | 0.59336 |
| 45 | −160.6608 | 7.4504 | | | |
| 46 | −492.6416 | 4.1681 | 1.76182 | 26.52 | 0.61361 |
| 47 | −81.1062 | 0.1232 | | | |
| 48 | 229.0858 | 9.5504 | 1.88300 | 40.76 | 0.56679 |
| 49 | 52.0025 | 0.1248 | | | |
| 50 | 46.5291 | 8.3550 | 1.51633 | 64.14 | 0.53531 |
| 51 | −70.4018 | 0.1198 | | | |
| 52 | 64.0556 | 8.4215 | 1.48749 | 70.23 | 0.53007 |
| 53 | −50.1526 | 2.3421 | 2.00100 | 29.13 | 0.59952 |
| 54 | 468.8769 | 4.1547 | 1.51633 | 64.14 | 0.53531 |
| 55 | −82.2655 | 0.2498 | | | |
| 56 | ∞ | 1.0000 | 1.51633 | 64.14 | 0.53531 |
| 57 | ∞ | 0.0000 | | | |
| 58 | ∞ | 33.0000 | 1.60863 | 46.60 | 0.56787 |
| 59 | ∞ | 13.2000 | 1.51633 | 64.14 | 0.53531 |
| 60 | ∞ | 17.3247 | | | |

TABLE 18
Example 5 - Specifications (d-line)

| | Wide Angle End | Middle | Telephoto End |
|---|---|---|---|
| Zoom Magnification | 1.0 | 48.0 | 103.0 |
| f′ | 8.69 | 417.32 | 895.50 |
| Bf′ | 47.45 | 47.45 | 47.45 |
| FNo. | 1.76 | 2.16 | 4.64 |
| 2ω [°] | 69.4 | 1.6 | 0.8 |

TABLE 19
Example 5 - Distances with respect to Zoom

| | Wide Angle End | Middle | Telephoto End |
|---|---|---|---|
| DD[10] | 2.1031 | 179.0734 | 184.9796 |
| DD[20] | 281.9252 | 39.0922 | 2.9115 |
| DD[25] | 6.7024 | 6.0644 | 1.1808 |
| DD[30] | 2.4569 | 68.9575 | 104.1158 |

TABLE 20
Example 5 - Aspheric Coefficients

| | Surface No. | | |
|---|---|---|---|
| | 11 | 22 | 26 |
| KA | 1.0000000E+00 | 1.0000000E+00 | 1.0000000E+00 |
| A4 | 1.5730579E−06 | 3.4196618E−08 | −3.3795215E−07 |
| A6 | 6.5856876E−11 | 3.6752602E−11 | 4.0016204E−11 |
| A8 | −2.2114707E−13 | −6.0806094E−15 | −1.5474428E−14 |
| A10 | 6.9670557E−16 | 5.8997611E−19 | 2.3256752E−18 |

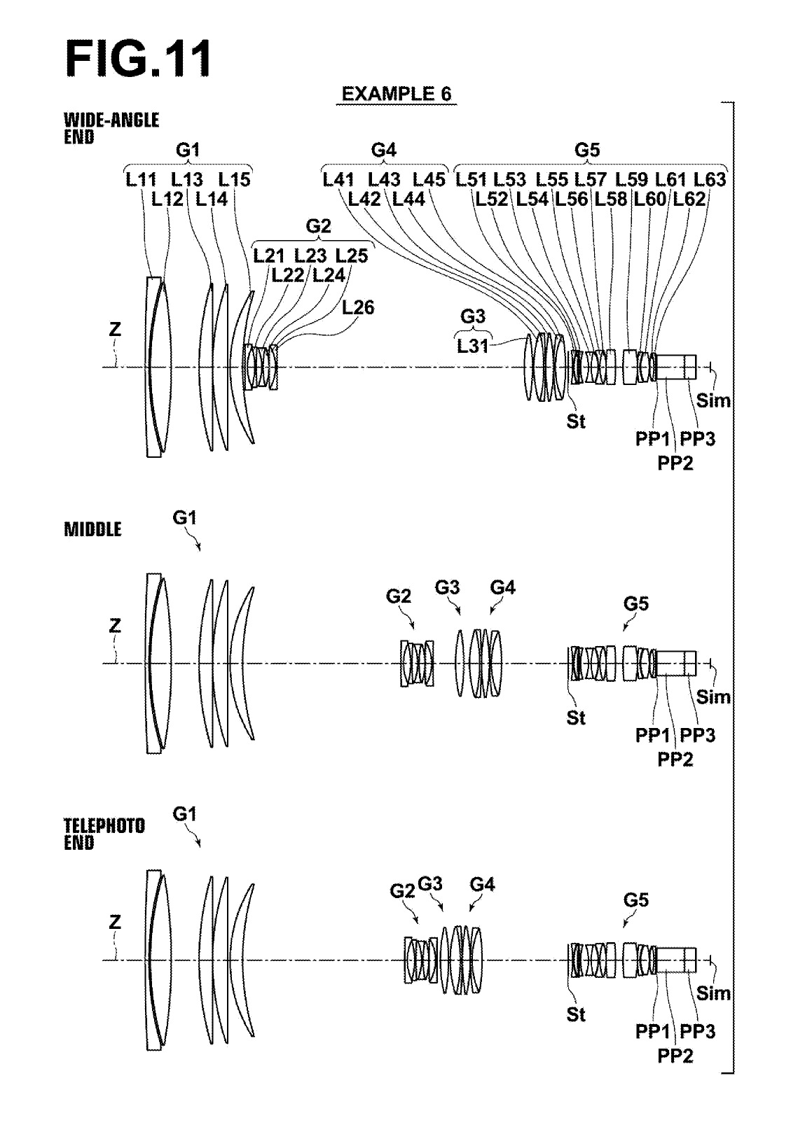

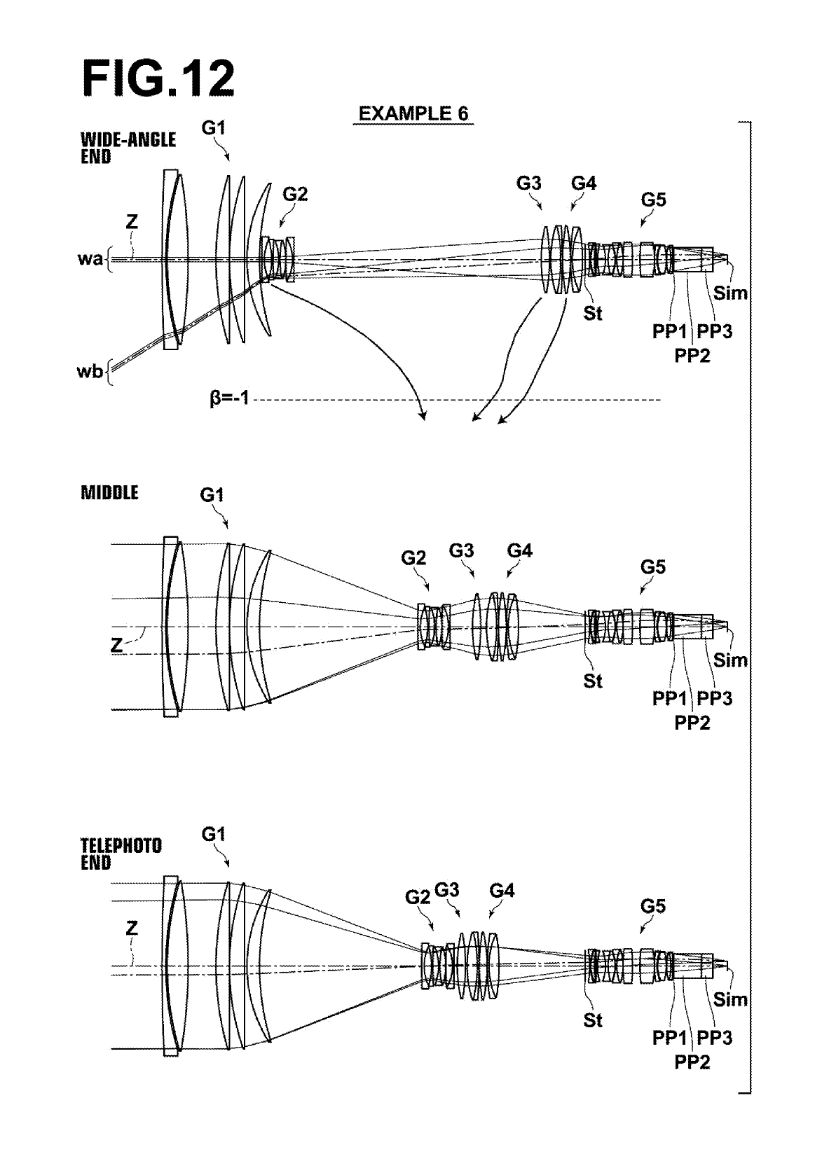

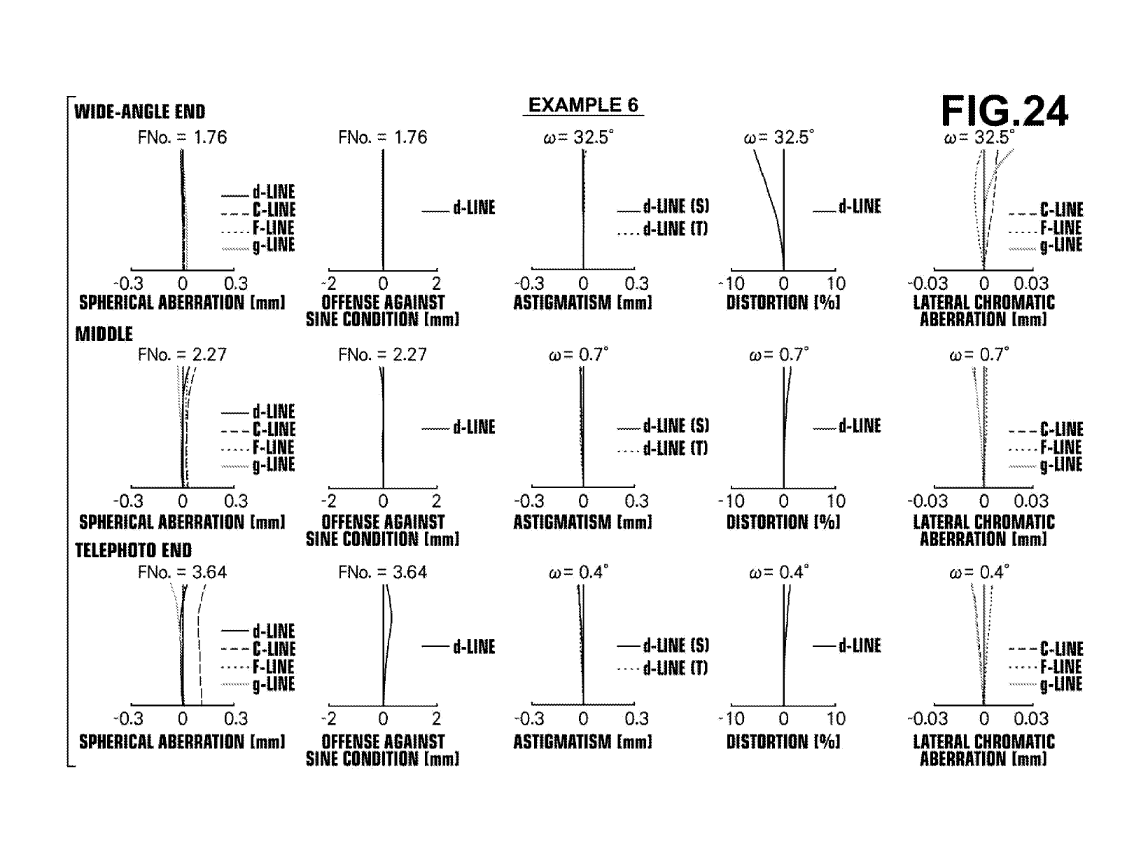

Next, a zoom lens of Example 6 is described. FIG. 11 is a sectional view illustrating the lens configuration of the zoom lens of Example 6, and FIG. 12 is a diagram showing optical paths through the zoom lens. The zoom lens of Example 6 differs from the zoom lens of Example 1 in that, in the zoom lens of Example 6, the fourth lens group G4 is formed by five lenses, i.e., lenses L41 to L45. Table 21 shows basic lens data of the zoom lens of Example 6, Table 22 shows data about specifications of the zoom lens, Table 23 shows data about surface distances to be changed of the zoom lens, Table 24 shows data about aspheric coefficients of the zoom lens, and FIG. 24 shows aberration diagrams of the zoom lens.

TABLE 21
Example 6 - Lens Data

| | Radius of | | | | |
|---|---|---|---|---|---|
| Surface No. | Curvature | Surface Distance | nd | νd | θg, F |
| 1 | 2149.2163 | 4.4000 | 1.83400 | 37.16 | 0.57759 |
| 2 | 364.4008 | 1.8100 | | | |
| 3 | 357.1559 | 24.5800 | 1.43387 | 95.18 | 0.53733 |
| 4 | −629.0299 | 32.8500 | | | |
| 5 | 363.8700 | 15.6200 | 1.43387 | 95.18 | 0.53733 |
| 6 | ∞ | 0.1200 | | | |
| 7 | 310.1672 | 17.8400 | 1.43387 | 95.18 | 0.53733 |
| 8 | ∞ | 2.9000 | | | |
| 9 | 173.0993 | 14.6700 | 1.43875 | 94.94 | 0.53433 |
| 10 | 310.0848 | DD[10] | | | |
| *11 | 109963.7968 | 2.8000 | 1.90366 | 31.31 | 0.59481 |
| 12 | 56.5266 | 8.6300 | | | |
| 13 | −84.6070 | 1.6000 | 2.00100 | 29.13 | 0.59952 |
| 14 | 321.4052 | 6.6700 | | | |
| 15 | −62.2824 | 1.6000 | 1.95375 | 32.32 | 0.59015 |
| 16 | 115.4560 | 6.9400 | 1.89286 | 20.36 | 0.63944 |
| 17 | −73.9497 | 0.1200 | | | |
| 18 | 962.3821 | 7.7100 | 1.80518 | 25.43 | 0.61027 |
| 19 | −51.3780 | 1.6200 | 1.80400 | 46.58 | 0.55730 |
| 20 | 2303.8825 | DD[20] | | | |
| 21 | 170.3657 | 9.7800 | 1.49700 | 81.54 | 0.53748 |
| *22 | −209.1383 | DD[22] | | | |
| 23 | 137.4359 | 11.9100 | 1.43700 | 95.10 | 0.53364 |
| 24 | −175.8090 | 2.0000 | 1.59270 | 35.31 | 0.59336 |
| 25 | −597.2019 | 0.2500 | | | |
| *26 | 188.3526 | 9.3100 | 1.43700 | 95.10 | 0.53364 |
| 27 | −195.4929 | 0.1200 | | | |
| 28 | 247.3158 | 2.0000 | 1.80000 | 29.84 | 0.60178 |
| 29 | 94.0850 | 12.0500 | 1.43700 | 95.10 | 0.53364 |
| 30 | −217.6314 | DD[30] | | | |
| 31 (stop) | ∞ | 5.0700 | | | |
| 32 | −188.3440 | 1.4000 | 1.77250 | 49.60 | 0.55212 |
| 33 | 62.0923 | 0.1200 | | | |
| 34 | 43.4903 | 4.5500 | 1.80518 | 25.42 | 0.61616 |
| 35 | 151.4362 | 2.0300 | | | |
| 36 | −188.3403 | 1.4000 | 1.48749 | 70.24 | 0.53007 |
| 37 | 72.1812 | 9.2600 | | | |
| 38 | −50.3918 | 3.2500 | 1.80440 | 39.59 | 0.57297 |
| 39 | 63.9801 | 8.1300 | 1.80518 | 25.43 | 0.61027 |
| 40 | −46.8126 | 0.3400 | | | |
| 41 | −50.8827 | 1.6600 | 1.95375 | 32.32 | 0.59015 |
| 42 | 56.9580 | 7.3800 | 1.72916 | 54.68 | 0.54451 |
| 43 | −73.6910 | 0.1200 | | | |
| 44 | 215.7126 | 10.9800 | 1.73800 | 32.26 | 0.58995 |
| 45 | −215.7126 | 8.8100 | | | |
| 46 | 182.7540 | 17.0600 | 1.67003 | 47.23 | 0.56276 |
| 47 | −103.9363 | 0.1200 | | | |
| 48 | 148.7010 | 2.9000 | 1.95375 | 32.32 | 0.59015 |
| 49 | 44.8210 | 0.8500 | | | |
| 50 | 44.9406 | 10.1300 | 1.51633 | 64.14 | 0.53531 |
| 51 | −64.7286 | 0.1200 | | | |
| 52 | 65.6410 | 5.1900 | 1.48749 | 70.24 | 0.53007 |
| 53 | −65.6410 | 1.8500 | 1.95375 | 32.32 | 0.59015 |
| 54 | ∞ | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.3299 | | | |

TABLE 22
Example 6 - Specifications (d-line)

| | Wide Angle End | Middle | Telephoto End |
|---|---|---|---|
| Zoom | 1.0 | 48.0 | 77.0 |
| Magnification | | | |
| f′ | 9.30 | 446.26 | 715.88 |
| Bf′ | 47.46 | 47.46 | 47.46 |
| FNo. | 1.76 | 2.27 | 3.64 |
| 2ω[°] | 65.0 | 1.4 | 0.8 |

TABLE 23
Example 6 - Distances with respect to Zoom

| | Wide Angle End | Middle | Telephoto End |
|---|---|---|---|
| DD[10] | 2.8554 | 186.6407 | 191.1526 |
| DD[20] | 291.2076 | 26.4986 | 3.9764 |
| DD[22] | 1.4039 | 6.7033 | 1.9940 |
| DD[30] | 3.1233 | 78.7475 | 101.4671 |

TABLE 24
Example 6 - Aspheric Coefficients

| | Surface No. | | |
|---|---|---|---|
| | 11 | 22 | 26 |
| KA | 1.0000000E+00 | 1.0000000E+00 | 1.0000000E+00 |
| A3 | −1.8505954E−21 | −7.1721817E−22 | 6.6507804E−22 |
| A4 | 4.0660287E−07 | 1.6421968E−07 | −2.8081272E−07 |
| A5 | −6.4796240E−09 | −5.6511999E−09 | −8.0962001E−09 |
| A6 | 8.4021729E−10 | 1.7414539E−10 | 2.8172499E−10 |
| A7 | −4.5016908E−11 | 7.4176985E−13 | −1.6052722E−12 |
| A8 | 4.3463314E−13 | −9.7299399E−14 | −1.0541094E−13 |
| A9 | 3.5919548E−14 | 1.1281878E−15 | 2.1399424E−15 |
| A10 | −8.9257498E−16 | −4.4848875E−19 | −1.0917621E−17 |

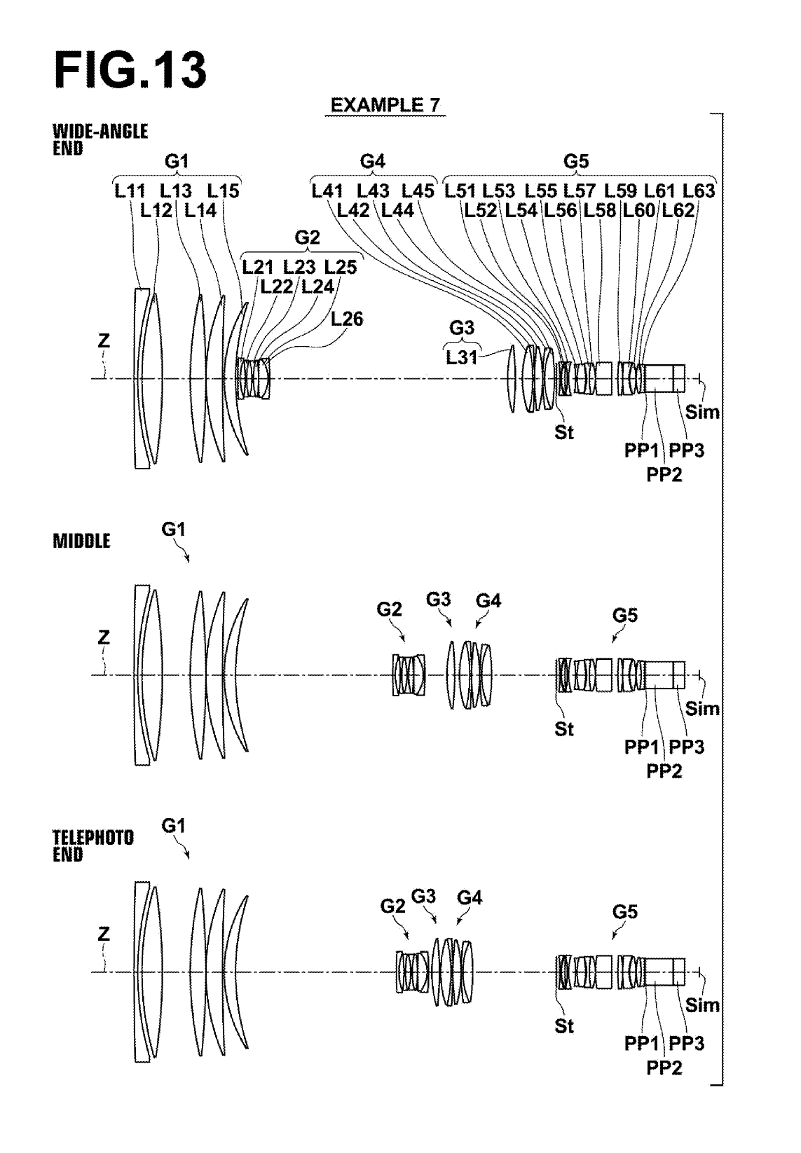

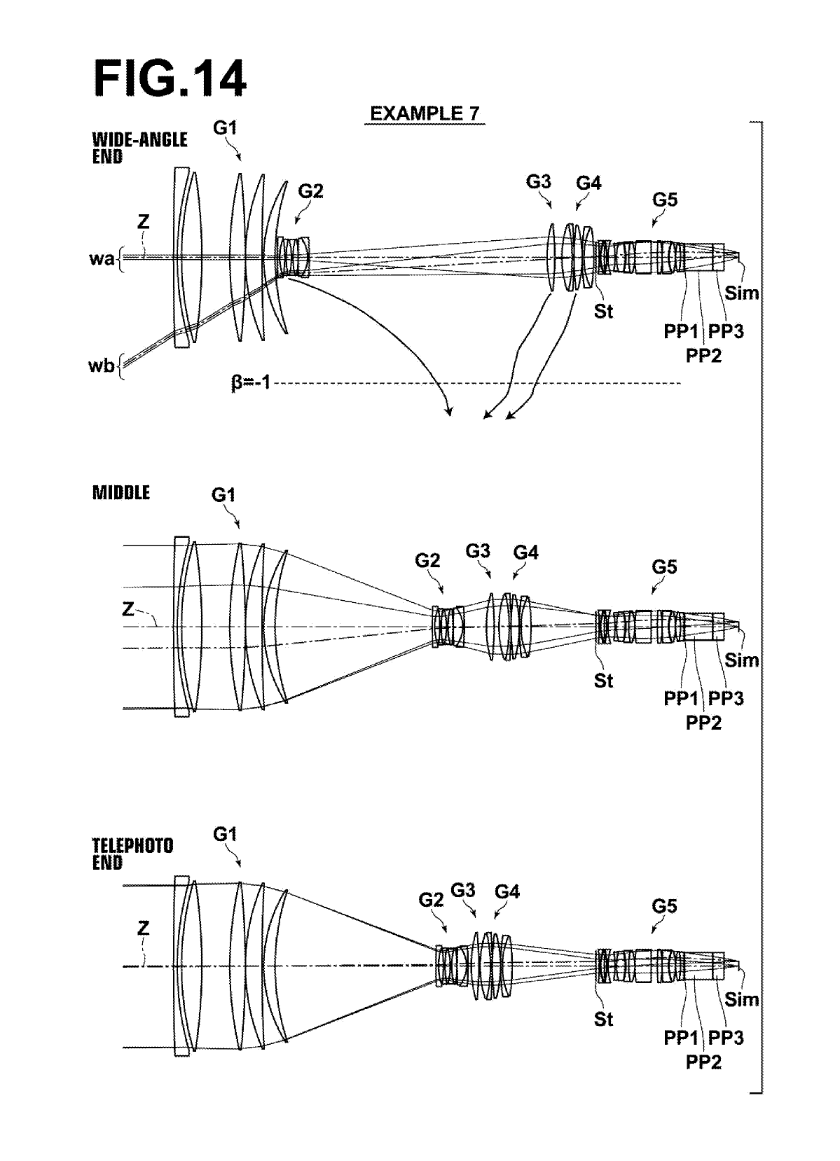

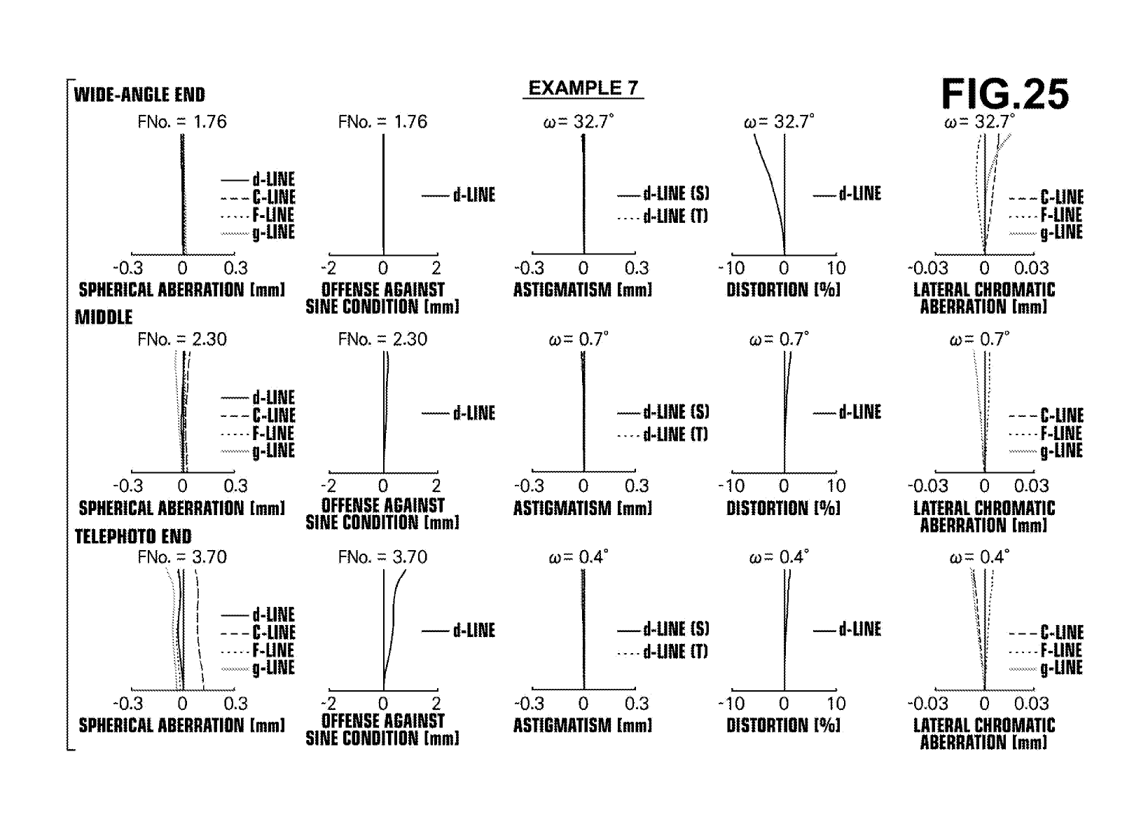

Next, a zoom lens of Example 7 is described. FIG. 13 is a sectional view illustrating the lens configuration of the zoom lens of Example 7, and FIG. 14 is a diagram showing optical paths through the zoom lens. The zoom lens of Example 7 is formed by the same number of lenses as the zoom lens of Example 6. Table 25 shows basic lens data of the zoom lens of Example 7, Table 26 shows data about specifications of the zoom lens, Table 27 shows data about surface distances to be changed of the zoom lens, Table 28 shows data about aspheric coefficients of the zoom lens, and FIG. 25 shows aberration diagrams of the zoom lens.

TABLE 25
Example 7 - Lens Data

| Surface | Radius of | Surface | | | |
|---|---|---|---|---|---|
| No. | Curvature | Distance | nd | νd | θg, F |
| 1 | 3475.3702 | 4.4000 | 1.83400 | 37.16 | 0.57759 |
| 2 | 372.4955 | 5.0357 | | | |
| 3 | 366.9209 | 23.9056 | 1.43387 | 95.18 | 0.53733 |
| 4 | −682.9236 | 32.9837 | | | |
| 5 | 454.1605 | 18.2207 | 1.43387 | 95.18 | 0.53733 |
| 6 | −986.9790 | 0.1100 | | | |
| 7 | 253.2817 | 19.6205 | 1.43387 | 95.18 | 0.53733 |
| 8 | 1947.2332 | 2.0966 | | | |
| 9 | 173.1049 | 13.3055 | 1.43875 | 94.94 | 0.53433 |
| 10 | 292.3182 | DD[10] | | | |
| *11 | 841.9448 | 2.8000 | 1.95375 | 32.32 | 0.59015 |
| 12 | 64.1193 | 5.9910 | | | |
| 13 | −139.9177 | 1.7000 | 2.00100 | 29.13 | 0.59952 |
| 14 | 103.9852 | 6.2479 | | | |
| 15 | −79.6795 | 1.7000 | 1.95375 | 32.32 | 0.59015 |
| 16 | 86.5057 | 6.0539 | 1.84666 | 23.83 | 0.61603 |
| 17 | −153.6438 | 0.1200 | | | |
| 18 | 487.2966 | 11.2129 | 1.80809 | 22.76 | 0.63073 |
| 19 | −38.0425 | 1.7000 | 1.81600 | 46.62 | 0.55682 |
| 20 | −403.3473 | DD[20] | | | |
| 21 | 152.9719 | 9.0813 | 1.59282 | 68.62 | 0.54414 |
| *22 | −317.0888 | DD[22] | | | |
| 23 | 126.9262 | 12.2707 | 1.43700 | 95.10 | 0.53364 |
| 24 | −172.5904 | 2.0000 | 1.59270 | 35.31 | 0.59336 |
| 25 | −585.3741 | 0.1200 | | | |
| *26 | 225.1390 | 9.6209 | 1.43700 | 95.10 | 0.53364 |
| 27 | −151.7222 | 0.1200 | | | |
| 28 | 263.3903 | 2.0000 | 1.80000 | 29.84 | 0.60178 |
| 29 | 88.7553 | 11.7320 | 1.43700 | 95.10 | 0.53364 |
| 30 | −232.3846 | DD[30] | | | |
| 31 (stop) | ∞ | 4.1987 | | | |
| 32 | −163.6964 | 1.5000 | 1.78800 | 47.37 | 0.55598 |
| 33 | 66.6579 | 0.1200 | | | |
| 34 | 46.2167 | 4.0850 | 1.76182 | 26.52 | 0.61361 |
| 35 | 152.4046 | 2.8557 | | | |
| 36 | −98.8029 | 1.5000 | 1.48749 | 70.24 | 0.53007 |
| 37 | 67.8883 | 8.2120 | | | |
| 38 | −103.2169 | 1.8000 | 1.83481 | 42.72 | 0.56486 |
| 39 | 62.9851 | 10.1794 | 1.84666 | 23.83 | 0.61603 |
| 40 | −74.4274 | 0.8479 | | | |
| 41 | −63.4207 | 3.4958 | 1.95375 | 32.32 | 0.59015 |
| 42 | 101.4326 | 7.1124 | 1.60311 | 60.64 | 0.54148 |
| 43 | −57.8040 | 0.1200 | | | |
| 44 | 127.8051 | 19.0888 | 1.61772 | 49.81 | 0.56035 |
| 45 | −5769.3694 | 7.1792 | | | |
| 46 | 244.7704 | 5.7290 | 1.58913 | 61.13 | 0.54067 |
| 47 | −108.1583 | 0.1200 | | | |
| 48 | 234.3868 | 7.4062 | 1.95375 | 32.32 | 0.59015 |
| 49 | 50.8661 | 0.7019 | | | |
| 50 | 51.8722 | 7.3813 | 1.58913 | 61.13 | 0.54067 |
| 51 | −74.1423 | 0.1500 | | | |
| 52 | 64.9784 | 5.7488 | 1.48749 | 70.24 | 0.53007 |
| 53 | −92.6312 | 3.8115 | 1.95375 | 32.32 | 0.59015 |
| 54 | −6201.4507 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.5370 | | | |

TABLE 26
Example 7 - Specifications (d-line)

| | Wide Angle End | Middle | Telephoto End |
|---|---|---|---|
| Zoom | 1.0 | 48.0 | 77.0 |
| Magnification | | | |
| f′ | 9.27 | 444.91 | 713.71 |
| Bf′ | 47.67 | 47.67 | 47.67 |
| FNo. | 1.76 | 2.30 | 3.70 |
| 2ω[°] | 65.4 | 1.4 | 0.8 |

TABLE 27
Example 7 - Distances with respect to Zoom

| | Wide Angle End | Middle | Telephoto End |
|---|---|---|---|
| DD[10] | 2.5512 | 185.1434 | 189.5366 |
| DD[20] | 280.2287 | 26.2040 | 3.9658 |
| DD[22] | 8.3473 | 5.5415 | 1.2476 |
| DD[30] | 2.3437 | 76.5819 | 98.7208 |

TABLE 28
Example 7 - Aspheric Coefficients

| | Surface No. | | |
|---|---|---|---|
| | 11 | 22 | 26 |
| KA | 1.0000000E+00 | 1.0000000E+00 | 1.0000000E+00 |
| A4 | 2.7395225E−07 | 1.1987876E−07 | −4.8883780E−07 |
| A6 | −4.8949478E−11 | 2.4237606E−11 | 2.3182674E−11 |
| A8 | 1.8491556E−13 | −2.9894229E−15 | −3.2052197E−15 |
| A10 | −1.9679971E−16 | −3.3833557E−19 | 9.7256769E−20 |

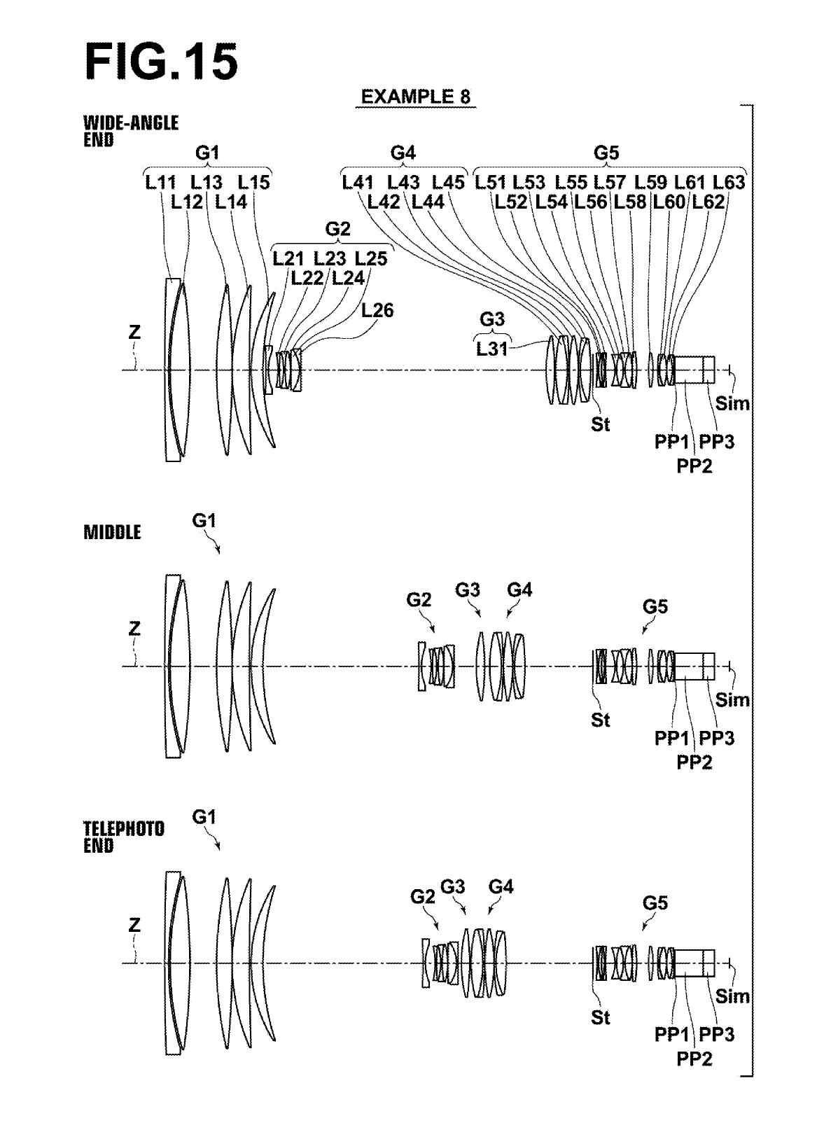

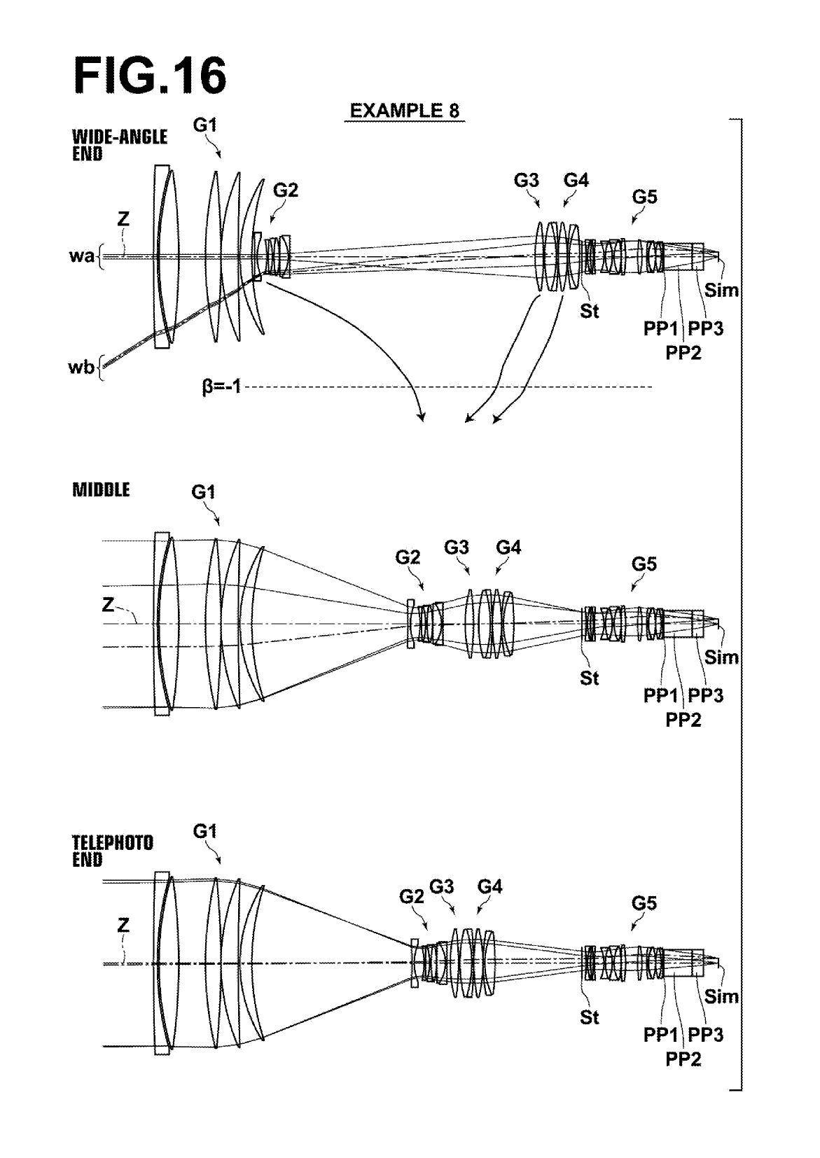

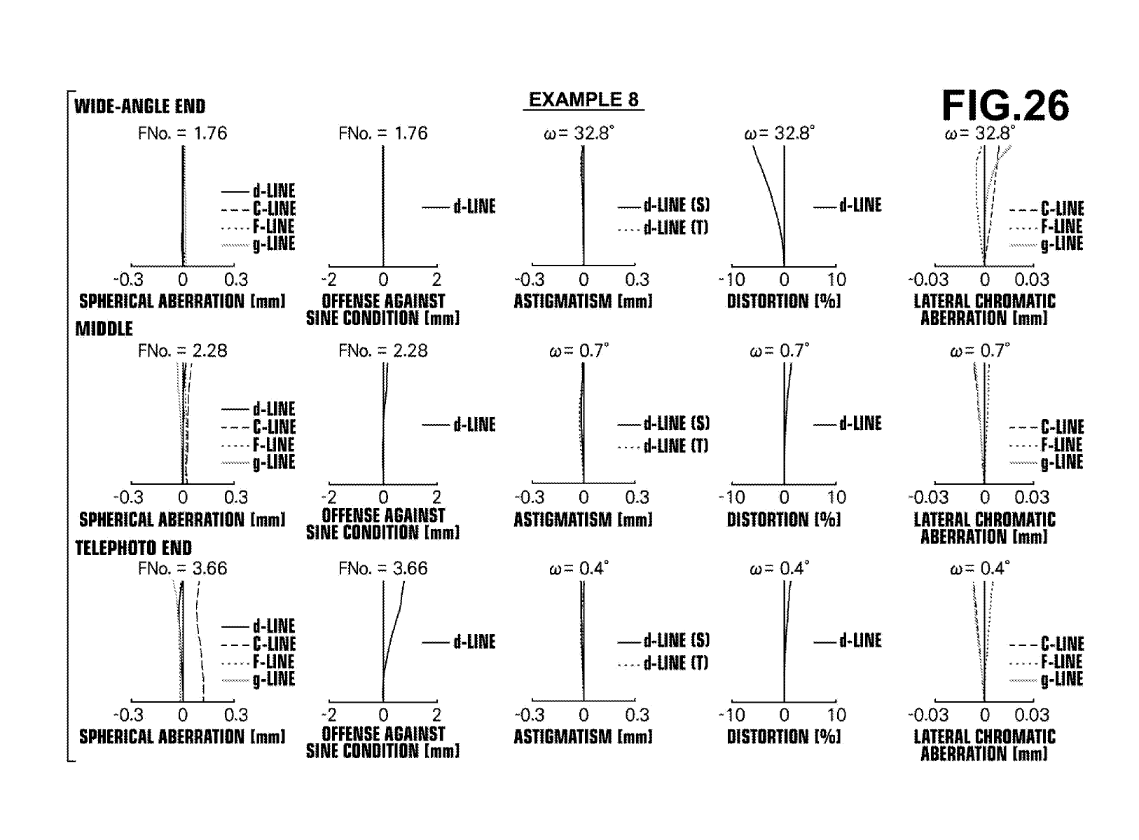

Next, a zoom lens of Example 8 is described. FIG. 15 is a sectional view illustrating the lens configuration of the zoom lens of Example 8, and FIG. 16 is a diagram showing optical paths through the zoom lens. The zoom lens of Example 8 is formed by the same number of lenses as the zoom lens of Example 6. Table 29 shows basic lens data of the zoom lens of Example 8, Table 30 shows data about specifications of the zoom lens, Table 31 shows data about surface distances to be changed of the zoom lens, Table 32 shows data about aspheric coefficients of the zoom lens, and FIG. 26 shows aberration diagrams of the zoom lens.

TABLE 29
Example 8 - Lens Data

| Surface | Radius of | Surface | | | |
|---|---|---|---|---|---|
| No. | Curvature | Distance | nd | νd | θg, F |
| 1 | 3055.3747 | 4.4000 | 1.83400 | 37.16 | 0.57759 |
| 2 | 372.1635 | 1.9397 | | | |
| 3 | 366.5958 | 22.9318 | 1.43387 | 95.18 | 0.53733 |
| 4 | −745.5153 | 30.9741 | | | |
| 5 | 447.2910 | 17.8731 | 1.43387 | 95.18 | 0.53733 |
| 6 | −1022.1176 | 0.1202 | | | |
| 7 | 250.7002 | 20.0594 | 1.43387 | 95.18 | 0.53733 |
| 8 | 2497.1844 | 2.0893 | | | |
| 9 | 173.5560 | 13.5554 | 1.43875 | 94.94 | 0.53433 |
| 10 | 296.5606 | DD[10] | | | |
| *11 | −536.2036 | 2.8000 | 1.90366 | 31.31 | 0.59481 |
| 12 | 59.0403 | 11.2534 | | | |
| 13 | −94.9158 | 1.7000 | 2.00100 | 29.13 | 0.59952 |
| 14 | 266.5653 | 4.8654 | | | |
| 15 | −73.3496 | 1.7000 | 1.95375 | 32.32 | 0.59015 |
| 16 | 114.5658 | 6.3833 | 1.89286 | 20.36 | 0.63944 |
| 17 | −87.7169 | 0.1202 | | | |
| 18 | 660.4559 | 10.0644 | 1.80518 | 25.43 | 0.61027 |
| 19 | −42.5900 | 1.7000 | 1.81600 | 46.62 | 0.55682 |
| 20 | 2697.8154 | DD[20] | | | |
| 21 | 163.2078 | 9.6780 | 1.53775 | 74.70 | 0.53936 |
| *22 | −262.8890 | DD[22] | | | |
| 23 | 161.2674 | 13.7150 | 1.43700 | 95.10 | 0.53364 |
| 24 | −135.7995 | 2.0000 | 1.59270 | 35.31 | 0.59336 |
| 25 | −425.7431 | 0.2500 | | | |
| *26 | 165.9002 | 10.7003 | 1.43700 | 95.10 | 0.53364 |
| 27 | −172.4386 | 0.1734 | | | |
| 28 | 209.1264 | 2.0000 | 1.80000 | 29.84 | 0.60178 |
| 29 | 88.7369 | 11.9532 | 1.43700 | 95.10 | 0.53364 |
| 30 | −285.7611 | DD[30] | | | |
| 31 (stop) | ∞ | 4.8788 | | | |
| 32 | −183.6883 | 1.5000 | 1.72916 | 54.68 | 0.54451 |
| 33 | 65.0566 | 0.1200 | | | |
| 34 | 46.1588 | 3.1785 | 1.89286 | 20.36 | 0.63944 |
| 35 | 74.9110 | 3.4315 | | | |
| 36 | −155.5064 | 1.5000 | 1.48749 | 70.24 | 0.53007 |
| 37 | 286.4381 | 10.8498 | | | |
| 38 | −46.9919 | 1.8000 | 1.95375 | 32.32 | 0.59015 |
| 39 | 54.2501 | 7.9488 | 1.84666 | 23.83 | 0.61603 |
| 40 | −45.8449 | 0.2577 | | | |
| 41 | −49.2346 | 1.8305 | 1.80100 | 34.97 | 0.58642 |
| 42 | 45.4781 | 8.0001 | 1.80400 | 46.58 | 0.55730 |
| 43 | −89.8875 | 0.1849 | | | |
| 44 | 377.4389 | 4.9915 | 1.57135 | 52.95 | 0.55544 |
| 45 | −154.4243 | 14.2327 | | | |
| 46 | 186.3239 | 4.9508 | 1.58267 | 46.42 | 0.56716 |
| 47 | −95.3723 | 5.4549 | | | |
| 48 | 144.8648 | 1.8002 | 1.95375 | 32.32 | 0.59015 |
| 49 | 45.1508 | 0.3951 | | | |
| 50 | 44.2996 | 8.0066 | 1.51633 | 64.14 | 0.53531 |
| 51 | −70.4722 | 0.1425 | | | |
| 52 | 65.0540 | 6.2761 | 1.48749 | 70.24 | 0.53007 |
| 53 | −59.8318 | 1.8002 | 1.95375 | 32.32 | 0.59015 |
| 54 | −463.5944 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 17.3431 | | | |

TABLE 30
Example 8 - Specifications (d-line)

| | Wide Angle End | Middle | Telephoto End |
|---|---|---|---|
| Zoom | 1.0 | 48.0 | 77.0 |
| Magnification | | | |
| f′ | 9.23 | 443.00 | 710.64 |
| Bf′ | 47.47 | 47.47 | 47.47 |
| FNo. | 1.76 | 2.28 | 3.66 |
| 2ω[°] | 65.6 | 1.4 | 0.8 |

TABLE 31
Example 8 - Distances with respect to Zoom

| | Wide Angle End | Middle | Telephoto End |
|---|---|---|---|
| DD[10] | 3.4238 | 181.0344 | 185.5983 |
| DD[20] | 284.5381 | 25.8471 | 3.9765 |
| DD[22] | 1.2485 | 5.8275 | 1.4969 |
| DD[30] | 2.6912 | 79.1928 | 100.8300 |

TABLE 32
Example 8 - Aspheric Coefficients

| | Surface No. | | |
|---|---|---|---|
| | 11 | 22 | 26 |
| KA | 1.0000000E+00 | 1.0000000E+00 | 1.0000000E+00 |
| A3 | −1.8734223E−21 | −9.4994419E−23 | −1.9744504E−22 |
| A4 | 4.0377651E−07 | 2.5885178E−08 | −3.7276810E−07 |
| A5 | 2.8838804E−08 | 8.1208148E−09 | −7.1416960E−09 |
| A6 | −2.3778998E−09 | −4.4404402E−10 | 6.1323910E−10 |
| A7 | −1.3752036E−10 | −1.1642324E−11 | −4.5003167E−12 |
| A8 | 3.3235604E−11 | 2.2808889E−12 | −1.8306327E−12 |
| A9 | −1.1806499E−12 | −3.8082037E−14 | 7.2409382E−14 |
| A10 | −1.1119723E−13 | −4.3094590E−15 | 1.7877810E−15 |
| A11 | 8.8174734E−15 | 1.5931457E−16 | −1.4970490E−16 |
| A12 | 9.1414991E−17 | 3.2617744E−18 | 4.0269046E−19 |
| A13 | −2.4438511E−17 | −2.2129774E−19 | 1.3563698E−19 |
| A14 | 2.8333842E−19 | −9.8414232E−23 | −1.9299794E−21 |
| A15 | 3.4151692E−20 | 1.4709791E−22 | −5.7156780E−23 |
| A16 | −7.6652516E−22 | −1.2247393E−24 | 1.3194211E−24 |
| A17 | −2.3926906E−23 | −4.6409036E−26 | 8.4439905E−27 |
| A18 | 7.0330122E−25 | 6.1748066E−28 | −3.3787964E−28 |
| A19 | 6.6810099E−27 | 5.3374486E−30 | 3.6923088E−31 |
| A20 | −2.3184109E−28 | −8.8908536E−32 | 2.2335912E−32 |

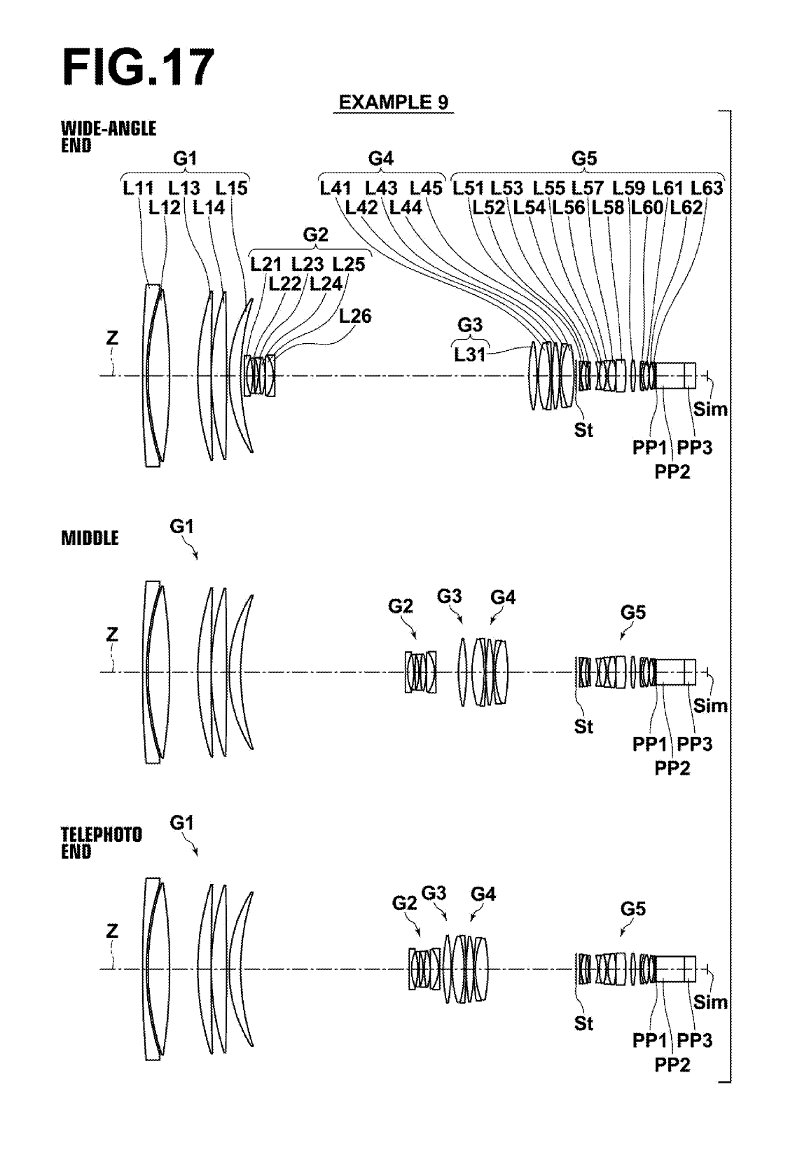

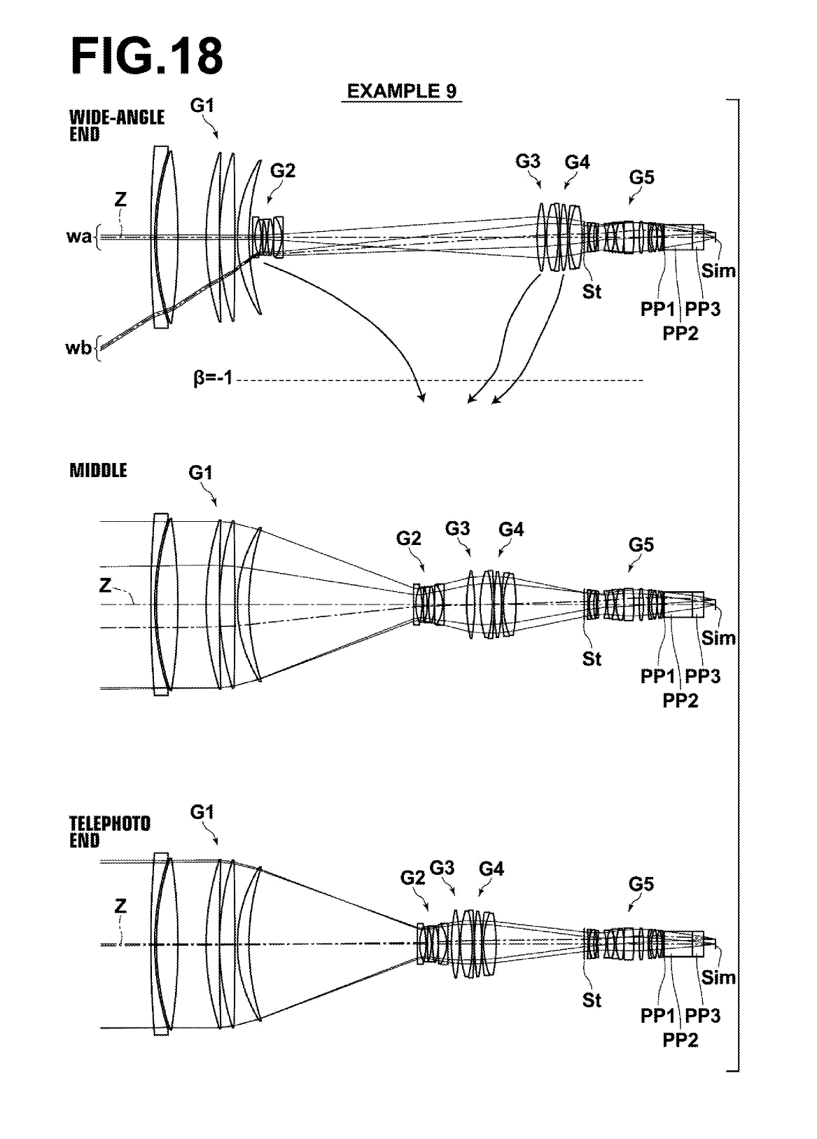

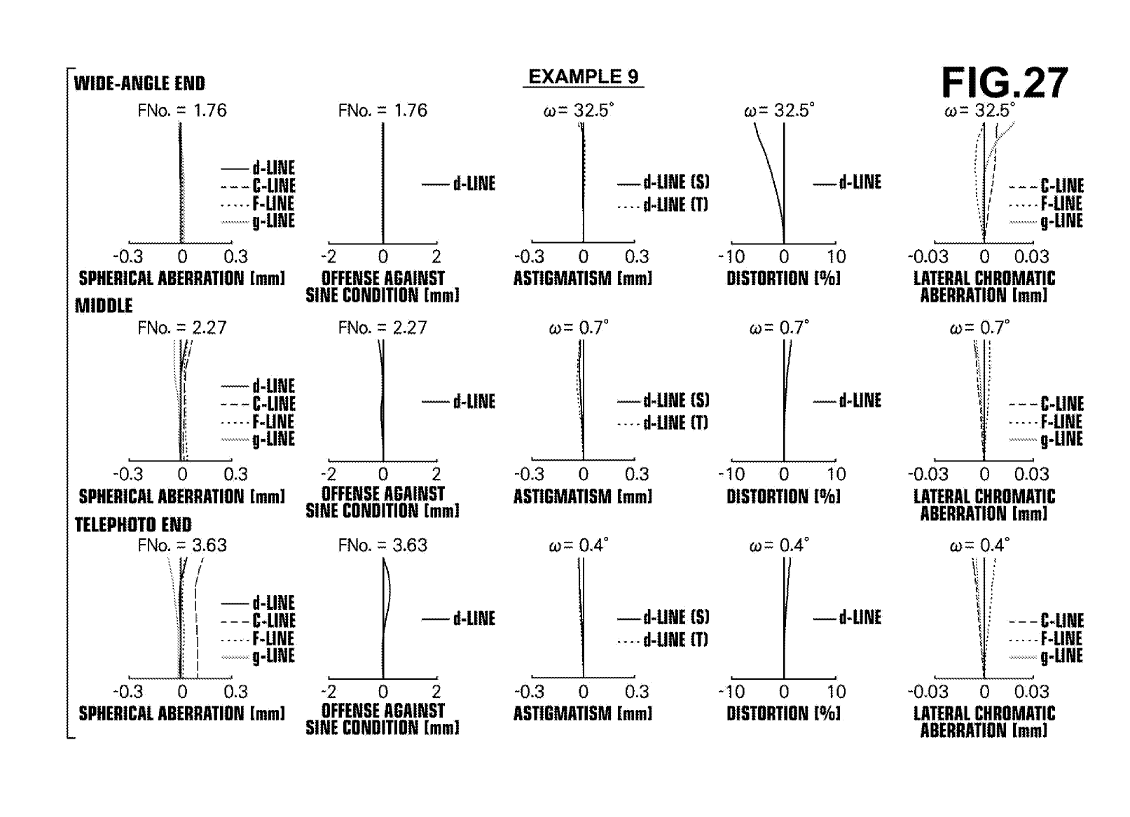

Next, a zoom lens of Example 9 is described. FIG. 17 is a sectional view illustrating the lens configuration of the zoom lens of Example 9, and FIG. 18 is a diagram showing optical paths through the zoom lens. The zoom lens of Example 9 is formed by the same number of lenses as the zoom lens of Example 6. Table 33 shows basic lens data of the zoom lens of Example 9, Table 34 shows data about specifications of the zoom lens, Table 35 shows data about surface distances to be changed of the zoom lens, Table 36 shows data about aspheric coefficients of the zoom lens, and FIG. 27 shows aberration diagrams of the zoom lens.

TABLE 33
Example 9 - Lens Data

| Surface | Radius of | Surface | | | |
|---|---|---|---|---|---|
| No. | Curvature | Distance | nd | νd | θg, F |
| 1 | 1404.7647 | 4.4000 | 1.83400 | 37.16 | 0.57759 |
| 2 | 331.7428 | 2.0290 | | | |
| 3 | 330.6824 | 25.1725 | 1.43387 | 95.18 | 0.53733 |
| 4 | −684.6165 | 32.8963 | | | |
| 5 | 332.8725 | 15.4555 | 1.43387 | 95.18 | 0.53733 |
| 6 | 3192.0621 | 0.1200 | | | |
| 7 | 330.0570 | 18.0043 | 1.43387 | 95.18 | 0.53733 |
| 8 | −4225.7159 | 2.9113 | | | |
| 9 | 173.7787 | 13.4351 | 1.43875 | 94.66 | 0.53402 |
| 10 | 294.8116 | DD[10] | | | |
| *11 | 3646.4256 | 2.8000 | 1.91082 | 35.25 | 0.58224 |
| 12 | 54.3093 | 7.3207 | | | |
| 13 | −83.4371 | 1.6000 | 2.00100 | 29.13 | 0.59952 |
| 14 | 337.9217 | 4.5408 | | | |
| 15 | −62.1882 | 1.6000 | 1.95375 | 32.32 | 0.59015 |
| 16 | 128.3598 | 6.5865 | 1.89286 | 20.36 | 0.63944 |
| 17 | −75.9599 | 0.1200 | | | |
| 18 | 629.8856 | 9.4791 | 1.79504 | 28.69 | 0.60656 |
| 19 | −42.5230 | 1.6200 | 1.77250 | 49.60 | 0.55212 |
| 20 | 2233.5230 | DD[20] | | | |
| 21 | 185.1580 | 9.3099 | 1.49700 | 81.54 | 0.53748 |
| *22 | −216.7260 | DD[22] | | | |
| 23 | 135.0164 | 14.0074 | 1.43875 | 94.66 | 0.53402 |
| 24 | −170.1053 | 2.0000 | 1.59270 | 35.31 | 0.59336 |
| 25 | −547.0734 | 0.2500 | | | |
| *26 | 212.2662 | 8.7456 | 1.43875 | 94.66 | 0.53402 |
| 27 | −201.9044 | 0.1200 | | | |
| 28 | 255.6587 | 2.0000 | 1.80000 | 29.84 | 0.60178 |
| 29 | 100.2233 | 14.6056 | 1.43875 | 94.66 | 0.53402 |
| 30 | −192.7222 | DD[30] | | | |
| 31 (stop) | ∞ | 4.4530 | | | |
| 32 | −327.4803 | 1.5000 | 1.72916 | 54.68 | 0.54451 |
| 33 | 69.9336 | 0.1200 | | | |
| 34 | 45.9379 | 5.2438 | 1.84661 | 23.88 | 0.62072 |
| 35 | 80.2736 | 3.2540 | | | |
| 36 | −136.5718 | 1.5000 | 1.48749 | 70.24 | 0.53007 |
| 37 | 172.9017 | 9.6930 | | | |
| 38 | −48.1573 | 1.5996 | 1.95375 | 32.32 | 0.59015 |
| 39 | 64.0378 | 7.9580 | 1.84661 | 23.88 | 0.62072 |
| 40 | −45.9067 | 0.2385 | | | |
| 41 | −49.7226 | 1.8719 | 1.80100 | 34.97 | 0.58642 |
| 42 | 50.1721 | 8.9651 | 1.80400 | 46.58 | 0.55730 |
| 43 | −90.0272 | 0.1198 | | | |
| 44 | 379.5125 | 11.4833 | 1.51742 | 52.43 | 0.55649 |
| 45 | −145.3944 | 6.4985 | | | |
| 46 | 185.6172 | 4.7307 | 1.54814 | 45.78 | 0.56859 |
| 47 | −90.8051 | 5.4933 | | | |
| 48 | 144.8094 | 1.4061 | 1.95375 | 32.32 | 0.59015 |
| 49 | 44.8523 | 2.4761 | | | |
| 50 | 45.7750 | 6.4411 | 1.51633 | 64.14 | 0.53531 |
| 51 | −73.1882 | 0.1199 | | | |
| 52 | 61.3330 | 5.4690 | 1.48749 | 70.24 | 0.53007 |
| 53 | −58.5284 | 1.3999 | 1.95375 | 32.32 | 0.59015 |
| 54 | −429.0874 | 0.2500 | | | |
| 55 | ∞ | 1.0000 | 1.51633 | 64.14 | 0.53531 |
| 56 | ∞ | 0.0000 | | | |
| 57 | ∞ | 33.0000 | 1.60863 | 46.60 | 0.56787 |
| 58 | ∞ | 13.2000 | 1.51633 | 64.14 | 0.53531 |
| 59 | ∞ | 13.9324 | | | |

TABLE 34
Example 9 - Specifications (d-line)

| | Wide Angle End | Middle | Telephoto End |
|---|---|---|---|
| Zoom | 1.0 | 48.0 | 77.0 |
| Magnification | | | |
| f′ | 9.30 | 446.43 | 716.14 |
| Bf′ | 44.06 | 44.06 | 44.06 |
| FNo. | 1.76 | 2.27 | 3.63 |
| 2ω[°] | 65.0 | 1.4 | 0.8 |

TABLE 35
Example 9 - Distances with respect to Zoom

| | Wide Angle End | Middle | Telephoto End |
|---|---|---|---|
| DD[10] | 4.1494 | 191.9872 | 196.6227 |
| DD[20] | 296.5791 | 26.5197 | 3.9711 |
| DD[22] | 1.5430 | 6.4538 | 1.2477 |
| DD[30] | 2.3959 | 79.7067 | 102.8260 |

TABLE 36
Example 9 - Aspheric Coefficients

| | Surface No. | | |
|---|---|---|---|
| | 11 | 22 | 26 |
| KA | 1.0000000E+00 | 1.0000000E+00 | 1.0000000E+00 |
| A3 | 2.7541588E−22 | −8.9652271E−22 | 6.6507804E−22 |
| A4 | 2.2200270E−07 | 1.5442509E−07 | −2.6398668E−07 |
| A5 | 3.6655960E−09 | −5.7414857E−09 | −1.0060099E−08 |
| A6 | 3.5909489E−11 | 1.4641121E−10 | 3.5807861E−10 |
| A7 | −1.9924682E−11 | 1.9156089E−12 | −2.2883080E−12 |
| A8 | 7.9185956E−13 | −9.8085610E−14 | −1.3269105E−13 |
| A9 | −5.7638394E−15 | 5.8482396E−16 | 2.9778250E−15 |
| A10 | −1.5115490E−16 | 5.8511099E−18 | −1.8171297E−17 |

Table 37 shows values corresponding to the condition expressions (1) to (4) of the zoom lenses of Examples 1 to 9. In all the examples, the d-line is used as a reference wavelength, and the values shown in Table 37 below are with respect to the reference wavelength.

TABLE 37

| No. | Condition Expression | Example 1 | Example 2 | Example 3 | Example 4 | Example 5 |
|---|---|---|---|---|---|---|
| (1) | νdG34n | 29.84 | 32.58 | 32.42 | 34.29 | 32.58 |
| (2) | ndL11 | 1.83400 | 1.83400 | 1.83400 | 1.83400 | 1.83400 |
| (3) | νdL11 | 37.16 | 37.34 | 37.16 | 37.16 | 37.16 |
| (4) | νd21 | 31.32 | 31.32 | 25.46 | 25.46 | 31.32 |

| No. | Condition Expression | Example 6 | Example 7 | Example 8 | Example 9 |
|---|---|---|---|---|---|
| (1) | νdG34n | 32.58 | 32.58 | 32.58 | 32.58 |
| (2) | ndL11 | 1.83400 | 1.83400 | 1.83400 | 1.83400 |
| (3) | νdL11 | 37.16 | 37.16 | 37.16 | 37.16 |
| (4) | νd21 | 31.31 | 32.32 | 31.31 | 35.25 |

As can be seen from the above-described data, all the zoom lenses of Examples 1 to 9 satisfy the condition expressions (1) to (4), and are compact, and have high optical performance, a high magnification of 77× or more, and a wide angle of view with a total angle of view of at least 65° at the wide-angle end.

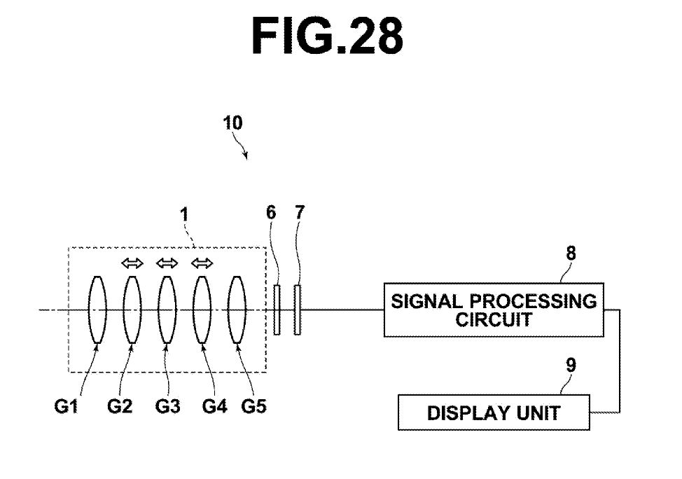

Next, an imaging apparatus according to an embodiment of the invention is described. FIG. 28 is a diagram illustrating the schematic configuration of an imaging apparatus employing the zoom lens of the embodiment of the invention, which is one example of the imaging apparatus of the embodiment of the invention. It should be noted that the lens groups are schematically shown in FIG. 28. Examples of the imaging apparatus may include a video camera and an electronic still camera which include a solid-state image sensor, such as a CCD (Charge Coupled Device) or CMOS (Complementary Metal Oxide Semiconductor), serving as a recording medium.

The imaging apparatus 10 shown in FIG. 28 includes a zoom lens 1; a filter 6 having a function of a low-pass filter, etc., disposed on the image plane side of the zoom lens 1; an image sensor 7 disposed on the image plane side of the filter 6; and a signal processing circuit 8. The image sensor 7 converts an optical image formed by the zoom lens 1 into an electric signal. As the image sensor 7, a CCD or a CMOS, for example, may be used. The image sensor 7 is disposed such that the imaging surface thereof is positioned in the same position as the image plane of the zoom lens 1.

An image taken through the zoom lens 1 is formed on the imaging surface of the image sensor 7. Then, a signal about the image outputted from the image sensor 7 is processed by the signal processing circuit 8, and the image is displayed on a display unit 9.

The present invention has been described with reference to the embodiments and the examples. However, the invention is not limited to the above-described embodiments and examples, and various modifications may be made to the invention. For example, the values of the radius of curvature, the surface distance, the refractive index, the Abbe number, etc., of each lens element are not limited to the values shown in the above-described numerical examples and may take different values.

What is claimed is:

1. A zoom lens consisting of, in order from an object side, a first lens group having a positive refractive power, a second lens group having a negative refractive power, a third lens group having a positive refractive power, a fourth lens group having a positive refractive power, and a fifth lens group having a positive refractive power,
wherein, during magnification change, the first lens group and the fifth lens group are fixed relative to an image plane, and the second lens group, the third lens group, and the fourth lens group are moved to change distances therebetween,
during magnification change from a wide-angle end to a telephoto end, the second lens group is moved from the object side toward the image plane side, and the fourth lens group is moved from the image plane side toward the object side,
during magnification change from the wide-angle end to the telephoto end, a third-fourth combined lens group, which is the combination of the third lens group and the fourth lens group, and the second lens group simultaneously pass through their respective points at which an imaging magnification is −1×,
the third-fourth combined lens group comprises at least one negative lens, and
the condition expression (1) below is satisfied:
29<νdG34n<37 (1),
where νdG34n is an average value of Abbe numbers with respect to the d-line of all negative lenses of the third-fourth combined lens group.

2. The zoom lens as claimed in claim 1, wherein the first lens group consists of, in order from the object side, a first-group first lens having a negative refractive power, a first-group second lens having a positive refractive power, a first-group third lens having a positive refractive power, a first-group fourth lens having a positive refractive power, and a first-group fifth lens which is a positive meniscus lens with a convex surface toward the object side, and
the condition expressions (2) and (3) below are satisfied:
1.75<ndL11 (2), and
νdL11<45 (3),
where ndL11 is a refractive index with respect to the d-line of the first-group first lens, and νdL11 is an Abbe number with respect to the d-line of the first-group first lens.

3. The zoom lens as claimed in claim 1, wherein a distance between the third lens group and the fourth lens group is maximized when they are on the wide angle side of their points at which the imaging magnification of the third-fourth combined lens group is −1×.

4. The zoom lens as claimed in claim 1, wherein a distance between the third lens group and the fourth lens group is minimized at the telephoto end.

5. The zoom lens as claimed in claim 1, wherein a distance between the second lens group and the third lens group at the telephoto end is smaller than that at the wide-angle end.

6. The zoom lens as claimed in claim 1, wherein the third lens group comprises at least one aspheric surface.

7. The zoom lens as claimed in claim 1, wherein the fourth lens group comprises at least one aspheric surface.

8. The zoom lens as claimed in claim 1, wherein a second-group first lens, which is the most object-side negative lens of the second lens group, satisfies the condition expression (4) below:
25<νd21<45 (4),
where νd21 is an Abbe number with respect to the d-line of the second-group first lens.

9. The zoom lens as claimed in claim 1, wherein the condition expression (1-1) below is satisfied:
29.5<νdG34n<36 (1-1).

10. The zoom lens as claimed in claim 2, wherein the condition expression (2-1) and/or (3-1) below is satisfied:
1.80<ndL11 (2-1),
νdL11<40 (3-1).

11. The zoom lens as claimed in claim 8, wherein the condition expression below (4-1) is satisfied:
28<νd21<40 (4-1).

12. An imaging apparatus comprising the zoom lens as claimed in claim 1.
